(19) United States
(12) Patent Application Publication
(10) Pub. No.: US 2021/0279603 A1
(43) Pub. Date: Sep. 9, 2021

(54) SECURITY SYSTEMS AND METHODS

(71) Applicant: SparkCognition, Inc., Austin, TX (US)

(72) Inventors: Jose Adalberto Teran Matus, Cedar Park, TX (US); Sridhar Sudarsan, Austin, TX (US)

(21) Appl. No.: 16/712,729

(22) Filed: Dec. 12, 2019

Related U.S. Application Data
(60) Provisional application No. 62/779,391, filed on Dec. 13, 2018.

(51) Int. Cl. G06N 5/04; G06F 16/28; G06N 20/00

(52) U.S. Cl. CPC G06N 5/04; G06N 20/00; G06F 16/285

(57) ABSTRACT

A method includes providing multiple datasets as input to a plurality of data reduction models to generate digest data and performing clustering to group the digest data into a plurality of clusters, where each cluster is associated with a subset of the digest data. The method also includes providing a subset of the digest data as input to event classifiers to generate event classification and evaluation data. The method also includes generating output based on the event classification data.

### CROSS-REFERENCE TO RELATED APPLICATION

The present application claims priority from U.S. Provisional Application No. 62/779,391 filed Dec. 13, 2018, entitled “SECURITY SYSTEMS AND METHODS,” which is incorporated by reference herein in its entirety.

### BACKGROUND

Technology is often used in security systems. For example, object detection and recognition technology can be used by law enforcement to identify faces of suspects, license plates of suspected vehicles, etc. As another example, natural language processing techniques can be used by government agencies to monitor and analyze communications.

### BRIEF DESCRIPTION OF THE DRAWINGS

FIG. 1 is a block diagram of an example of a system according to the present disclosure.

FIG. 2 is a block diagram of another example of the system of FIG. 1 according to the present disclosure.

FIG. 3 is a block diagram of another example of the system of FIG. 1.

FIG. 4 illustrates a particular example of the system of FIG. 1 disposed in a geographic area with one or more unmanned vehicles.

FIG. 5 is a block diagram of a particular example of a hub device.

FIG. 6 is a block diagram of a particular example of an unmanned vehicle.

FIG. 7 is a flow chart of a particular example of a method that can be initiated, controller, or performed by the system of FIG. 1.

FIG. 8 is a diagram illustrating details of one example of the automated model builder instructions of FIG. 1.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

According to particular aspects, public safety systems can be improved by using artificial intelligence (AI) to analyze various types and modes of input data in a holistic fashion. For example, video camera output can be analyzed using AI models to identify suspicious objects left unattended in places (e.g., airports), people or objects in a “wrong” or prohibited place or time, etc. Accomplishments in deep learning and improved computing capabilities enable some systems to go a step further. For example, in a particular aspect, a system can identify or predict very specific events based on multiple and distinct data sources that generate distinct types of data. As another example, events and event responses can be simulated using complex reasoning based on available evidence. Notifications regarding identified or predicted events can be issued to relevant personnel and automated systems. Furthermore, remedial actions can be recommended, or in some cases, automatically initiated using automated response system, such as unmanned vehicles.

As an illustrative non-liming example, in response to a prediction that there is a greater than 10% chance that a bank robbery is in progress or is about to occur, a security system described herein may automatically launch one or more unmanned aerial vehicles (UAVs) to the location of the bank robbery, where the launched UAV(s) include sensors/payloads (e.g., cameras) that can assist law enforcement in apprehending suspects (and also provide additional sensor input to the security system for use in further decision making) In some examples, UAVs, unmanned land vehicles, unmanned water vehicles, unmanned submersible vehicles, and/or unmanned hybrid vehicles (e.g., operable on land and in the air) are available for deployment. Sensors on-board an unmanned vehicle may include, but are not limited to, visible or infrared cameras, ranging sensors (e.g., radar, lidar, or ultrasound), acoustic sensors (e.g., microphone or hydrophones), etc.

In an aspect, the present disclosure provides an intelligent system and method using machine learning to detect events based on disparate data, to provide recommendations on actions and insights for detecting special circumstances that require attention. The system and method use data from multiple data sources, such as video cameras, recorded video, data from one or more sensors, data from the internet, audio data, media data sources, databases storing structured and/or unstructured data, etc.

In an aspect, the described system is trained using labeled training data derived from previously saved data corresponding to special circumstances that have been identified and documented. To illustrate, the labeled training data may include video footage of a person carrying (or concealed carrying) a weapon, video/images of persons in a criminal database or in video footage captured near a scene of interest, sound of weapons being used, explosions, people reacting to weapon use or other events (e.g., screaming), a fire detected by infrared sensors, social media posts or news posts describing criminal activity, sensor data captured during a particular event, emergency call center (e.g., “911” in the U.S.) transcripts or audio, etc. In an aspect, the system uses cognitive algorithms to “learn” what makes a circumstance of interest, and the system's learning is reinforced by human feedback that confirms whether an identification output by the system was accurate (e.g., was an event that needed to be highlighted and analyzed further).

In some examples, the described system can consider opinions from multiple humans. For example, multiple instances of the system may be used by respective human operators, and feedback from the human operators may be weighted based on whether the human operators had the same or different opinion of whether an event classification was correct. In some examples, the described system learns preferences of individual human operators and is calibrated to provide insights to a human operator based on that human operator's preferences.

In a particular aspect, the system is configured to assign a level, priority, and/or emergency designation among other relevance criteria based on analyzed data. For example, the level, priority, and/or emergency designation may be assigned based on one or more of recognized face(s) of people previously involved in criminal activity, amount/nature of detected or previous criminal activity, potential number of people that could be affected by the event, activity classification (e.g., terrorism, kidnapping, street fight, armed assault, etc.), involvement of weapons (e.g., number, type, etc.) and/or other important events, behaviors or objects identified in the scene.

In a particular aspect, the system may use a variety of machine learning strategies based on the data type of data that are being analyzed. To illustrate, different machine learning strategies may be used based on format(s) of received data, volume of received data, quality of received data, etc. The system may also use input from other data sources, input from subject matter experts, user input, and/or imported results from other systems (including other instances of the same system). Data types accessed by the system may include, but are not limited to: sensor data streams, video data, audio data, internet data (e.g., news feeds, social media feeds, etc.), or emergency communications data (panic button, phone calls, video calls, chats, etc.). Real-time, near-real-time, and/or stored data may be input into the system. Machine learning strategies employed by the system can include deep learning for video analytics (e.g., object recognition or tracking), natural language processing, neural networks, genetic algorithms, etc. The system may, based on execution of one or more trained models, analyze the data to identify data related to common events, identify the type or severity of an event, and recommend one or more response actions for an event. The system may also optionally identify people or objects, including but not limited to people or objects involved directly or indirectly in a crime or relevant event. The system may attempt to match identified faces/people in a criminal database and may generate output reporting based on whether a match was found. If a match was not found, the detected face (or other identification) may optionally be stored in an alternate database, for example so that the stored information can be used to try identify the person using existing infrastructure.

To illustrate, the severity (or weight) assigned to a detected event may be based on type/amount of weaponry detected, whether gunfire or explosions have been detected, the number of individuals involved, estimated number of bystanders, types of vehicles in and around the area, information regarding individual identified via facial recognition, witness reports, whether unauthorized individuals or vehicles (including potentially autonomous vehicles) are near a prohibited zone, etc. In some examples, the system assigns weight based at least in part on supervised training iterations during which a human operator indicates whether a weight assigned to an event was too high, too low, etc. In a particular aspect, the number, nature, and/or recipient(s) of notifications regarding a detected event changes based on the weight(s) assigned to the event.

The disclosed system may also analyze other types of data. For example, the system may search public and private sources, such as the internet (e.g., social media or other posts, real-time news, dark web, etc.), for information regarding events in a geographical region of interest, interpret the data in context and “give meaning” to the data, classify the data, and assign a credibility index as well as weight the data with multiple relevance parameters (e.g., dangerousness, alarm, importance, etc.). The system may also automatically send reports or notifications regarding such events to users configured to receive such notifications. The system may generate recommendations regarding response actions and resource allocations/deployments. In some examples, the system can provide post-event information that can assist an investigation, searching the internet for relevant data related to an event that occurred within the monitored geographical or virtual area, etc.

Thus, in some aspects, an event-driven system in accordance with the present disclosure may determine what actions should be taken and what resources should be used, based on training of the AI module(s) of the system, subject matter expert (SME) input, and iterative/feedback-driven learning from previous decisions.

In some aspects, the described system may automatically generate training data for use in training subsequent generation(s) of the machine learning models utilized in the system. To illustrate, after the system detects, weights, and classifies an event, data regarding the event may be stored as training data. The training data may include one or more of the input signals that led to the event detection, the weights assigned to the event, the classification of the event, human operator feedback regarding the event (e.g., whether the classification was correct, whether the weights were too high/too low, whether the actions suggested by the system were taken, etc.), time taken for dispatched resources to arrive at a destination, whether the suggested actions helped resolve the event, weather conditions, traffic conditions, or other events that may have affected the outcome (e.g., a protest or march in the surrounding areas, a sporting event, etc.). The stored data may be used as supervised training data when a subsequent generation of a machine learning model is trained. Training data may be generated based on both detected events as well as signal inputs that resulted in no event being detected.

In a particular aspect, the system provides explainable AI output that includes a human-understandable explanation for the event detection, weighting, classification, and/or suggested actions. Such explanations may be especially important, if not mandated, by regulatory authorities (e.g., under a social “right to explanation”) in the context of security decisions that impact public safety. In an illustrative example, if the system recommends certain actions in response to detecting for example a bank robbery, the system may output an explanation indicating that the similar actions led to successful apprehension of criminals within 24 hours in a prior bank robbery scenario. As another example, the system may output frames of videos in which a particular weapon was detected, and pixels corresponding to the weapon may be visually distinguished (e.g., highlighted or outlined).

In a particular aspect, the models utilized by the described system are trained, at least in part, based on trained event libraries (TELs). TELs may be general or may be specific to particular types of events, geographic areas, etc. To illustrate, a TEL used to train a security system for use in one part of the world may assign a high degree of suspicion to a person carrying an open flame torch, whereas a different TEL for a different part of the world may assign little meaning to such an event when analyzing the context and circumstances. Conversely, certain things may be universal from a security standpoint (e.g., a firearm being fired). TELs can be created that contain the training for specific events. These TELs may be exported, imported, combined, enhanced, added, deleted, exchangeable, etc.

In one example, a TEL protocol is used to standardize the format and communications associated with a TEL library. The TEL protocol may support multiple types of data inputs, both, structured and structured such as video, audio, text, digital sensors, infrared sensors, vibration sensors, etc.

Crime and violence have reached alarming levels in some places in the world, and despite some governments investing large amount of resources on crime/violence prevention, a lack of accurate predictions on where and when such events will occur results in less-than-adequate preventative/remedial measures. In many cases, authorities do not have enough resources or have resources in the wrong place at the wrong time.

In accordance with various aspects of the present disclosure, a computer system is configured to predict a “risk index” (e.g., with respect to criminal activity) for a particular geographical or virtual area. The risk index may be determined based on historic data as well as real-time, near-real-time, or stored input. To illustrate, the system may receive input regarding events that are currently occurring. The system may utilize the risk index values of various areas in evaluating available resources and outputting recommendations regarding where and when resources should be deployed or relocated, whether and what type of additional resources should be acquired, etc.

In a particular aspect, the described system analyzes an area, dividing the area into one or multiple zones based on concentration of relevant events. Alternatively, a user may manually designate zone boundaries or modify zone boundaries automatically generated by the system. The system may analyze historical risk for each zone based on past events that occurred during a relevant period of time. The system may assign weights to each zone, where more weight is assigned to a zone that has repetitive incidences of events and/or where zones having more recent events are assigned higher weights.

Risk events may be classified through multiple relevance parameters, for example accidents and type of accident, violations and type of violation, crime and type of crime, weapons in scene (e.g., presence of weapons, types of weapons, number of weapons), criminals recognized in scene, etc. The system may “learn” what is relevant based on initial training of machine learning models and further based on feedback in the form of input from subject matter experts or human operators of the system and dynamically modify a “heat” for the risk index for each zone.

Various events may be analyzed by the system to determine and update risk indexes. Such events may include, but are not limited to: seasons, historical trends, environmental conditions (e.g., weather, time of day, illumination, day of week, and holidays), etc.

In a particular aspect, the system also analyzes data received via the internet, social media feeds, dark web, video cameras, audio inputs, apps, emergency services calls, intelligence information, satellite data, sensor output data, data received from universities and research centers (e.g., regarding predictive modeling for earthquakes, hurricanes, and other natural phenomena), etc. The system may process such information in determining the risk index for one or more of the zones. In an example, the system may also receive and analyze information from the above-described event-driven system that analyzes video, audio, internet, 911 calls, etc.

According to a particular aspect, the system evaluates a risk index against the resources in and around each zone within the monitored geographic or virtual area. When the available resources are predicted to be inadequate to respond to an event (e.g., resources are insufficient, underutilized, over utilized, etc.) in the short, medium, and/or long term, the system generates alerts. Such alerts may be classified by multiple parameters of relevance and urgency (as in the case for the above-described event-driven system). Different level alerts may be communicated to different individuals, systems or subsystems for follow-up action, such as need of resource relocation, resource deployment, resource acquisition, resource reassignment, etc. In some examples, the system considers distance and duration of travel with respect to resources from surrounding zones in determining whether sufficient resources are available to respond to a particular event under different environmental (e.g., weather) scenarios. Thus, the system may generally, in view of the determined risk indexes for various zones, analyze available resources capabilities and features of the resources, distances between zones, environmental conditions, risk index trends of zones, and per-zone resources need predictions. The system may propose one or more solutions to address the predictions for the short term and may optionally recommend other changes or acquisitions for the medium or long term. Depending on implementation, the system may utilize genetic algorithms, heuristic algorithms, and/or machine learning models during operation.

In a particular aspect, when the risk index for a zone changes, the system automatically initiates an analysis (with or without participation from users and other systems). The system may collect documentation of changes that happened in or around the zone and that directly or indirectly affected the risk index. Subsequent generations of risk index determination models may be trained based on such data to more accurately determine risk indexes and suggest resource actions.

In an example, the described zone-driven system (that may be receiving as an input the result of the event-driven system described above and/or additionally receiving input based on emergency calls, police reports, internet data and/or other sources) analyzes what is happening in a zone as well as in the zones around that zone. The zone-driven system may analyze the resources available and features of the available resources. Based on what resources are available, the zone-driven system may make a recommendation regarding how to use those resources, in consideration of what is happening in multiple zones and the predictions in those multiple zones. Hence, in such an example, the zone-driven system may not suggest an action based on just a single event, but rather based on numerous events happening in the zone and surrounding zones of interest and based on available resources. The zone-driven system can also make recommendations for resources needed in the long run and can provide support information based on what is happening (at a given time) to justify the acquisition of more assets, technologies, hiring of more personnel (e.g., police), or implementing certain training to personnel.

In some cases, a single system has, or a combination of systems collectively have, access to a database indicating available security resources, its location and/or status. Such resources may be classified by: type; features; feature importance according to type of event; weight and grade of dangerousness/relevance/importance; dependency of resource on other resources; and/or correlation of effectiveness with events, other resources and other environmental, physical, and/or situational conditions. Resources can include human response personnel, vehicles (autonomous and/or non-autonomous), etc. Such a system (or combination of systems) may monitor locations and availability of various resources, and may use this information in determining what resources should be deployed to address a particular event that has been detected. For example, the system(s) may consider distance and travel time in determining which available resource(s) are to be deployed to deal with a detected bank robbery. In some cases, the system(s) output a recommendation to a human operator regarding the suggested resources. In other cases, the system(s) automatically dispatch at least some of the suggested resources (e.g., the system may command a UAV that is in-flight to reroute itself to the site of the bank robbery or may send a message to launch a previously grounded UAV to the site of the bank robbery). In one implementation, the system(s) is configured to output a likelihood of the suggested/dispatched resources contributing to a desired outcome (e.g., the likelihood that deploying UAVs equipped with cameras to follow a getaway vehicle will lead to eventual capture of bank robbers). Dispatched unmanned vehicles may generally gather sensor readings/data, interact with objects in the environment, carry a cargo payload to a destination, etc.

While several of the foregoing aspects are described with reference to security, it is to be understood that the techniques of the present disclose can also be used in other contexts. As a first example, the system can be used before, during and after a natural disaster, such as an earthquake. Prior to the occurrence of an earthquake, the system can evaluate zones that were more severely and/or commonly damaged by previous earthquakes, improvements (e.g., building code/structural improvements) made since the last earthquake and expected results from such improvements, available resources, resource distribution, etc. The system may suggest re-distribution of resources or suggest reinforcement in certain areas that the executed machine learning models predict as having a higher risk index for an earthquake. During an earthquake, the system can receive inputs from diverse sources including video, unmanned vehicles, sensors, emergency calls, rescue teams, and other sources and dynamically recommend resource allocation/distribution to assist with search and rescue operations. After the earthquake response is completed, the system can document the efficacy of its recommended actions and generate training data that can be used to train subsequent generation(s) of models so that future event detections/classifications, risk index predictions, and suggested actions are more accurate and effective.

As another example, the system can be used before, during, and after an epidemic in a certain geographical region. Prior to the occurrence of the epidemic, the system can evaluate zones that were more severely and/or commonly hit by previous disease outbreaks, improvements (e.g., general hygiene, immunizations, etc.) made since the last outbreak and expected results from such improvements, available resources, resource distribution, etc. The system may suggest re-distribution of resources or suggest reinforcement in certain areas that the executed machine learning models predict as having a higher risk index for an outbreak. During an outbreak, the system can receive inputs from diverse sources including video, unmanned vehicles, sensors, emergency calls, medical facilities and personnel, and other sources and dynamically recommend resource allocation/distribution to assist with medical and epidemiological operations (e.g., containment, patient treatment, inoculation, sample testing, etc.). Post-outbreak, the system can document the efficacy of its recommended actions and generate training data that can be used to train subsequent generation(s) of models so that future event detections/classifications, risk index predictions, and suggested actions are more accurate and effective.

Thus, in particular aspects, the described system enables a proactive approach using AI to dynamically predict the risk index per zone and allocate/reallocate resources, as well as to determine if more resources are needed, and when and how to distribute such resources.

Public safety is a problem in places where crime has reached levels that are affecting daily citizen life. Even though budgets assigned to control this problem are substantial, existing solutions are not designed to anticipate reallocation of resources to maximize efficiencies. Currently solutions to these problems are provided manually by humans, but this does not scale and it is impossible to react in timely fashion due to the large quantity of inputs and the time it takes to process them, as well as due to the constant change in the modus operandi of organized crime. Thus, the techniques of the present disclosure do not merely automate an activity previously performed manually or in the human mind. Rather, the described techniques solve specific computing challenges. Using models that are trained using training data and supervised learning, and/or trained using unsupervised learning techniques, the system can quickly process the high volume and varied types of available input signals. The models may identify signals that are most highly correlated with successful detection/prediction, and based on those signals, generate output that can be used for security purposes.

Different techniques may be used on different combinations of signals. Recurrent, convolutional, and/or LSTM neural networks may be used to process video and detect events based on a sequence of multiple frames. Audio data may be processed using deep learning techniques to perform audio fingerprinting, matching, feature extraction/comparison, etc. Internet data, emergency call data, etc. may be analyzed using natural language processing algorithms Convolutional neural networks may be used to analyze photos images and video by security cameras, images uploaded to social media, etc. Machine learning models that may be used in conjunction with the present disclosure include, but are not limited to, reinforcement learning models, natural language processing models, trained classifiers, regression models, clustering models, anomaly detectors, etc. Based on the output of the various models being executed by the system, alerts may be issued and certain resources may be automatically be deployed, relocated to a different area, etc.

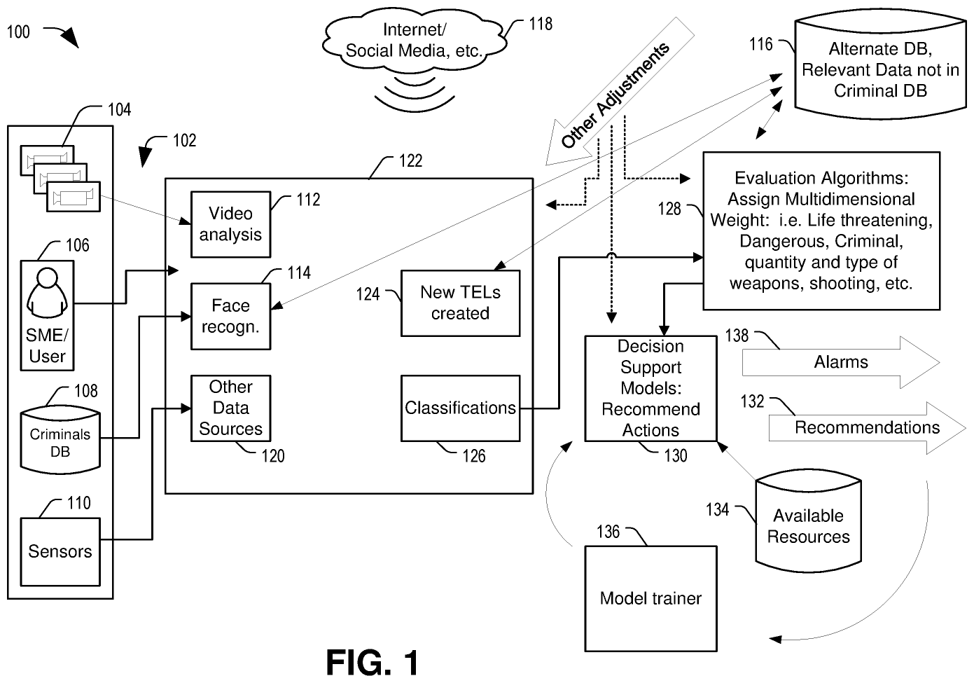

FIGS. 1-4 illustrate particular embodiments of systems in accordance with the present disclosure. It is to be understood that in alternative examples, a system implementing the described techniques may include components from both FIGS. 1-4.

In FIG. 1, a system 100 receives input signals 102 such as video from one or more cameras 104 (which can include fixed and/or mobile cameras), input from subject matter experts (SMEs) or users 106, input from law enforcement/criminal activity databases 108, and input from other sources 120 (e.g., audio data, infrared sensors, thermal sensors, etc.).

Machine learning algorithms and models 122 perform holistic analysis of the input signals 102 to detect, identify, and respond to events. Video may be analyzed to identify events, behaviors, objects, faces, etc. using models (e.g., video analysis models 112) trained on TELs. A face recognition model 114 can compare faces detected in the video with law enforcement databases (e.g., a criminals database 108) and, optionally, alternate databases 116 that supplement law enforcement databases (e.g., if law enforcement databases do not reveal a face match, images posted to various social media sites 118 may be searched for a face match). The system 100 optionally may create the alternate database 116 where it will store the faces or other means of identification of people involved directly or indirectly in a crime or relevant event and that probably are or are not stored in the criminal databases 108 in order to identify and locate these people later. Other data sources 120, including sensors 110, ambient environment characteristics, social media posts, structured data, legacy system databases, and Internet data 118, etc. may be used as further inputs to refine event detection (e.g., influence a confidence value output by the model for the detected event). New TELs 124 may also be created (or existing TELs may be augmented) based on some or all of the input signals 102. In some cases, other adjustments may be received from different instances of the system, TELs, etc.

Event classifications 126 and structured data output by the models 122 may be input into evaluation models and algorithms that may correlate the data and findings to generate additional data to be evaluated by the algorithms 128. For example, multidimensional weights may be assigned to the events based on whether the events are deemed to be life-threatening, dangerous, criminal, the quantity and type of weapons detected, whether a shooting was detected, etc. Evaluation output may be provided to decision support models 130, which may initiate alarms 138 and/or determine recommendations 132 regarding action(s) to take in response to the detected event. The recommended action(s) may be determined based on available resources 134, and the decision support models 130 may be adjusted (e.g., by a model trainer 136) based on whether the recommended action(s) were taken and/or whether they were successful.

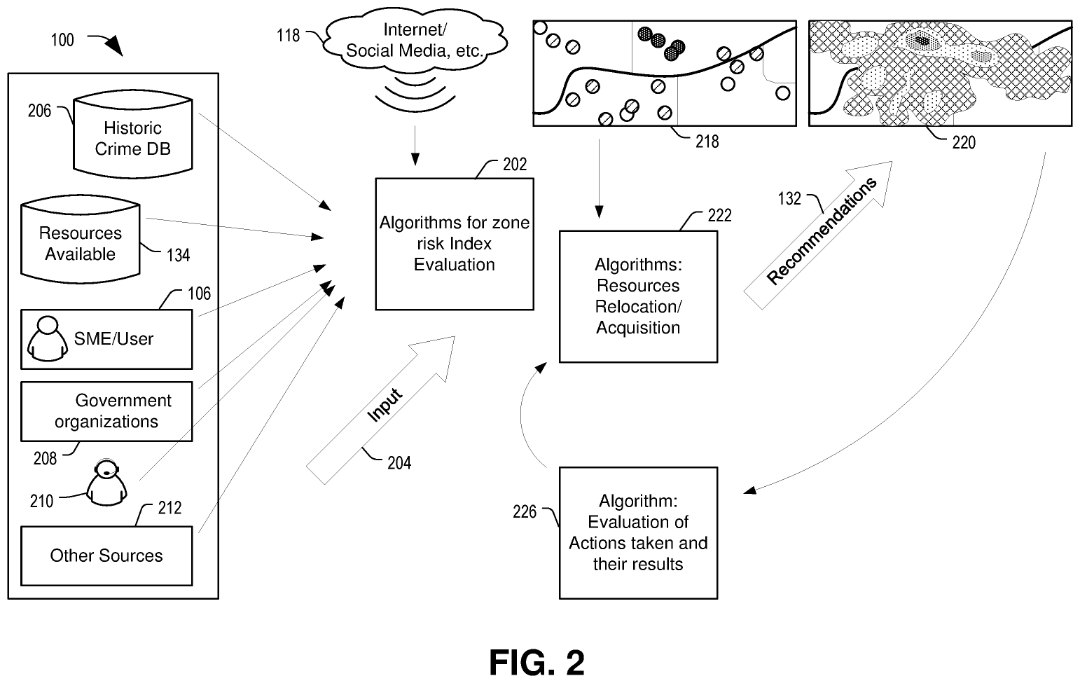

In FIG. 2, the system 100 includes models/algorithms 202 for zone risk index evaluation, which receive input 204 from historical law enforcement/crime databases 206, information regarding available resources, SMEs/users 106, government organizations 208 (e.g., a secret service type organization if a head of state is visiting the area), dispatch personnel 210, social media and internet data 118, resource location data, and other sources 212. The input 204 can also be received from other sources as illustrated in FIG. 1. Risk index values may be output for each of a plurality of zones 218, 220.

Models/algorithms for resource relocation and acquisition 222 may take the risk index values as input and may determine a set of recommendations 132 or trigger automatic actions regarding the available resources. Decision support models/algorithms 226 may evaluate results of taken actions, so that decision models can be adjusted. Feedback may also be received from the field and/or may be entered by users.

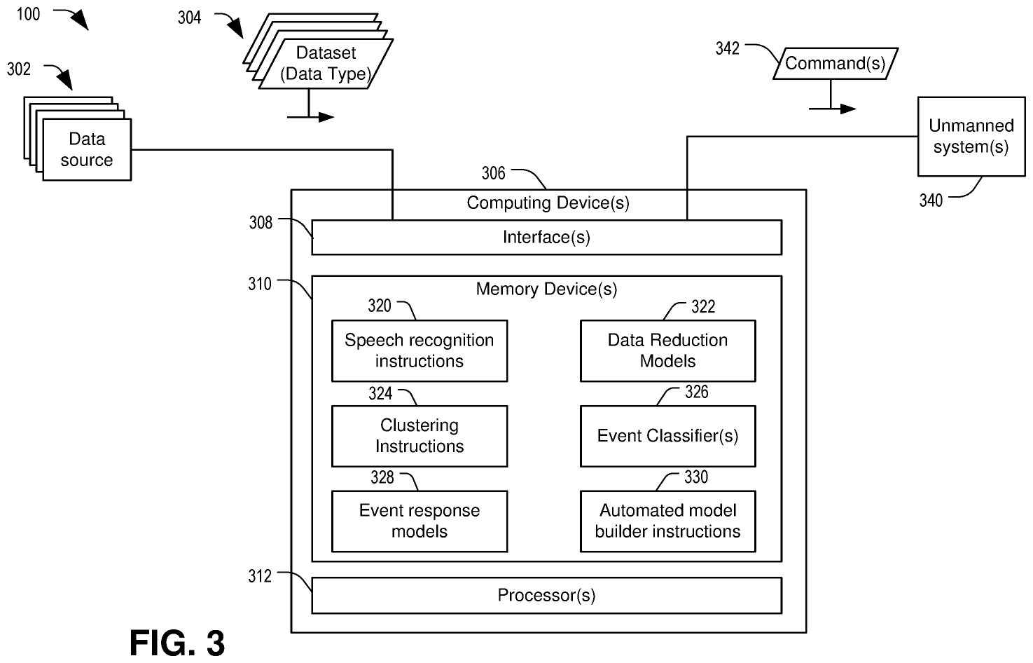

FIG. 3 illustrates additional details of an example of the system 100. In FIG. 3, the system 100 includes a plurality of data sources 302 each of which generates a respective dataset 304. The datasets 304 include a plurality of different data types. For example, the data sources 302 can correspond to or include the camera(s) 104, the users 106, the databases 108, and/or the other sources 120 of FIG. 1. In this example, the camera(s) 104 generate a dataset that includes video data and the users 106 generate a dataset that includes natural language text or audio data. To illustrated, a particular dataset can include natural language text derived from content of one or more social media posts or moderated media content (e.g., radio, television, dark web, or internet news sources). The datasets 304 can also, or in the alternative, include other data types, such as sensor data, still images, database records, etc.

One or more computing devices 306 obtain the datasets 304 via one or more interfaces 308. In some implementations, one or more of the datasets 304 are obtained directly from respective data sources 302, such as via a direct wired signal path (e.g., a high-definition media interface (HDMI) cable). In some implementations, one or more of the datasets 304 are obtained via a network or relay device from respective data sources 302, such as via internet protocol packets or other packet-based communications. In some implementations, one or more of the datasets 304 are obtained via wireless transmissions from respective data sources 302. Further, one or more of the datasets 304 can be obtained by the computing device(s) 306 responsive to a data request (which may be referred to as a pull protocol), one or more of the datasets 304 can be obtained by the computing device(s) 306 without individual data requests (e.g., via a push protocol), or some of the datasets 304 can be obtained via a pull protocol and others of the datasets 304 can be obtained via a push protocol.

The data sources 302 can include public sources (e.g., internet-based data sources), private sources (e.g., local sensor, proprietary databases/systems, legacy systems databases), government sources (e.g., emergency call center transcripts), or a combination thereof. Further, in some implementations, one or more of the data sources 302 may be integral to the computing device(s) 306. For example, the computing device(s) 306 include one or more memory devices 310, which may store a database that includes one of the datasets 304.

The memory device(s) 310 also store data and instructions that are executable by one or more processors 312 to perform operations described herein. In FIG. 3, the memory device(s) 310 store speech recognition instructions 320, data reduction models 322, clustering instructions 324, one or more event classifiers 326, event response models 328, and automated model builder instructions 330. In other implementations, the memory device(s) 310 store additional data or instructions, or one or more of the models or instructions illustrated in FIG. 3 are stored remotely from the computing device(s) 306. For example, the automated model builder instructions 330 can be stored at or executed at a computing device distinct from the computing device(s) 306 of FIG. 3. Further, in some implementations, one or more of the models or instructions illustrated in FIG. 3 are omitted. For example, the speech recognition instructions 320 are executable by the processor(s) 312 to process audio data to recognize words or phrases therein and to output corresponding text. Accordingly, if none of the datasets 304 include audio data from which text is to be derived, then the speech recognition instructions 320 can be omitted.

The data reduction models 322 include machine learning models that are trained to generate digest data based on the datasets 304. In this context, digest data refers to information that summarizes or represents at least a portion of one of the datasets 304. For example, digest data can include keywords derived from natural language text or audio data; descriptors or identifiers of features detected in image data, video data, audio data, or sensor data; or other summarizing information.

Generally, each data reduction model is configured to process a corresponding data type, structured or unstructured. For example, a first data reduction model may include a natural language processing model trained or configured to extract terms of interest (e.g., keywords) from text, such as social media posts, news articles, transcripts of audio data (which may be generated by the speech recognition instructions or another transcription source), etc. In this example, a second data reduction model may include a classifier or a machine learning model that is trained to generate a descriptor based on features extracted from a sensor data stream. Further, in this example, a third data reduction model may include an object detection model trained or configured to detect particular objects, such as weapons, in image data or video data and to generate an identifier or a descriptor of the detected object. In some implementations, a fourth data reduction model may include face recognition model trained or configured to distinguish human faces in image data or video data and to generate a descriptor (e.g., a name and/or other data, such as a prior criminal history) of a detected person. Other examples of data reduction models 322 include vehicle recognition models that generate descriptors of detected vehicles (e.g., color, make, model, and/or year of a vehicle), license plate reader models that generate license plate numbers based on license plates detected in images or video, sound recognition models that generate descriptors of recognized sounds (e.g., gunshots, shouts, alarm claxons, car horns), meteorological models that generate descriptors of weather conditions based on sensor data, etc. The digest data also includes or is associated with (e.g., as metadata) time information and location information associated with at least one dataset of the datasets 304.

After the data reduction models 322 generate the digest data, the digest data is provided as input to the clustering instructions 324. The clustering instructions 324 use supervised or unsupervised machine learning operations to attempt to group the digest data into event-related groupings (referred to herein as clusters) in a multidimensional feature space. For example, the clustering instructions 324 can include support vector machine instructions that are configured to identify boundaries between a specified set of event-related groups and to assign each data elements of the digest data to a respective event-related group. As another example, the clustering instructions 324 can include hierarchical clustering instructions (e.g., agglomerative or divisive clustering instructions) that group the data elements of the digest data into an unspecified set of groupings which are proposed as event-related groups. In other implementations, the clustering instructions 324 include density-based clustering instructions, such as DBSCAN or OPTICS.

Each related group of data (e.g., each cluster) represents a portion of the datasets related to (or expected to be related to) a single event. For example, the multidimensional feature space can include a time axis, one or more location axes (e.g., two or more location axes to enable specification of a map coordinate), and axes corresponding to other features derived from the digest data. In this example, a first pair of digest data elements with similar features and associated with similar times and locations are expected to be located nearer to one another in the feature space than a second pair of digest data elements with dissimilar features, associated with similar times, and/or associated with distant locations. Accordingly, the first pair of digest data elements are likely to be associated with a single event and are likely to be in the same cluster with one another, and the second first pair of digest data elements are likely to be associated with different events and are likely to be in different clusters.

Data from each cluster is provided as input to one or more of the event classifiers 326 to generate event classification data. For example, a first subset of the digest data corresponding to a first cluster is input to one or more of the event classifiers 326 to generate first event classification data for the first cluster. In this example, the first event classification data indicates an event classification for a portion of the datasets 304 represented by the first cluster. Similarly, another subset of the digest data corresponding to another cluster is input to one or more of the event classifiers 326 to generate event classification data for the other cluster. Thus, after execution of the clustering instructions 324 and the event classifiers 326, the datasets 304 are grouped into event-related groupings and each event-related grouping is associated with event classification data.

The event classification data indicates a type of event, a severity of the event, a confidence value, or a combination thereof. In some instances, the event classifiers 326 may be unable to assign event classification data with sufficient confidence (e.g., greater than a threshold value) to a particular cluster. In such instances, the cluster can be re-evaluated, alone or with other data, by the clustering instructions 324 to determine whether the cluster is actually associated with two or more distinct events. In some implementations, the cluster can be re-evaluated by the clustering instructions 324 after a delay to allow additional related data to be gathered from the data sources 302.

In some implementations, the computing device(s) 306 generate output based on the event classification data. For example, one or more of the alarms 138 of FIG. 1 may be generated when the event classification data indicates that a particular type of event is detected in the datasets 304. In some implementations, the event classification data may be used to select a particular one of the event response models 328 to execute to generate a response recommendation (e.g., one of the recommendations 132 of FIGS. 1 and 2) or to select a response action. For example, each event response model 328 may be configured or trained to generate a response recommendation for a particular type of event or a particular set of types of events. To illustrate, a first event response model may be configured to generate response recommendations for structure fire events, and a second event response model may be configured to generate response recommendations for robberies.

During execution of an event response model, a portion of the digest data, a portion of the raw data from the datasets 304, or both, may be provided as input to the event response model. The event response models 328 can include heuristic rules, machine learning models, or both. For example, certain response actions can be generated based on rules that map particular event types to corresponding actions, such as a command 342 transmitted by the interface(s) 308 to dispatch one or more unmanned systems 340 (e.g., monitoring drones) to an area associated with a particular type of event. Other response actions can be determined using a machine learning model to predict an appropriate response action. For example, the machine learning model can include a neural network, a decision tree, or another machine learning model trained to select a response action that is most likely to achieve one or more results, such as minimizing or reducing causalities, minimizing or reducing property loss, optimal or acceptable use of resources, or combinations thereof. In some implementations, an event response model 328 performs a response simulation for a particular type of event (e.g., based on a time and location associated with the event, available resources, historical responses, etc.) to select the response action taken or recommended. For some event types, one or more response actions may be selected based on heuristic rules and one or more additional response action may be selected based on response simulation. To illustrate, when a structure fire event is detected, a nearest available fire response team may be automatically dispatched to the structure fire based on a heuristic rule. In this illustrative example, a machine learning-based event response model can be executed, using available data, to project whether one or more additional fire response teams or other resources (e.g., police) should also be dispatched.

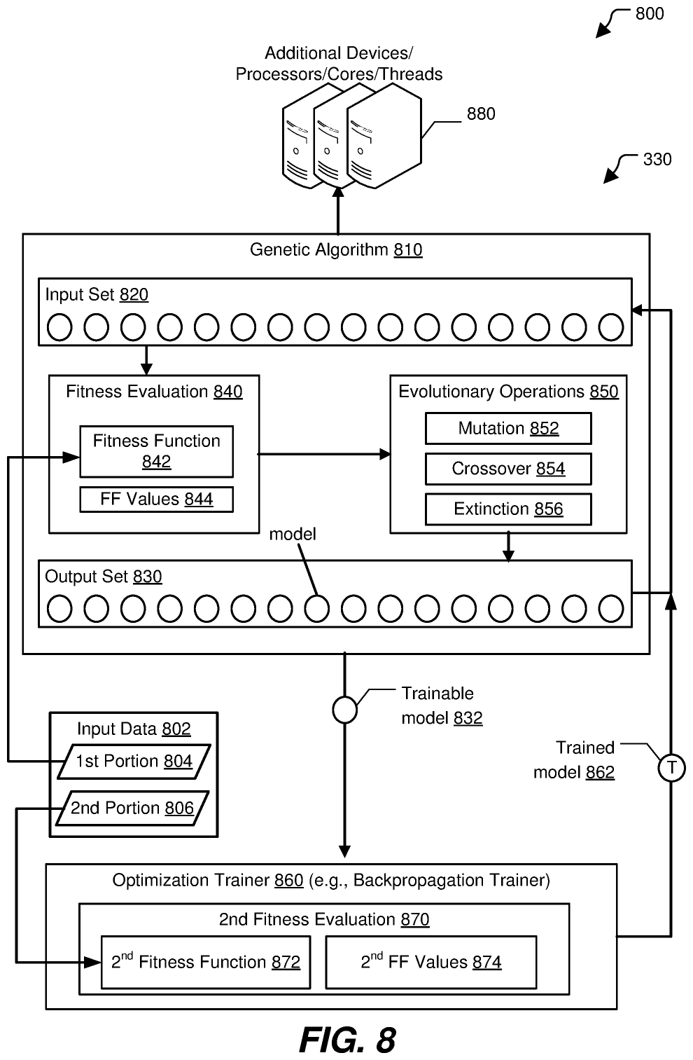

In FIG. 3, the memory device(s) 310 also include the automated model builder instructions 330 which are executable by the processor(s) 312 to update one or more of the speech recognition instructions 320, the data reduction models 322, the clustering instructions 324, the event classifiers 326, or the event response models 328. FIG. 8 illustrates one particular example of an automated model building process that can be implemented by the automated model builder instructions 330. As an example, initially, the automated model builder instructions 330 can be provided with labeled training data (e.g., one or more of the TELs described above) and the automated model builder instructions 330 can generate the speech recognition instructions 320, the data reduction models 322, the clustering instructions 324, the event classifiers 326, the event response models 328, or a combination thereof, based on the labeled training data.

Additionally, or in the alternative, after an event is detected and/or a response action is taken, a user or one of the data sources 302 can provide the computing device(s) 306 with information indicating whether an event classification provided by the event classifiers 326 was correct, whether digest data generated by the data reduction models 322 was correct, whether clusters identified by the clustering instructions 324 were correct, what specific response actions were actually taken (whether the actual response actions correspond to the recommended response actions or not) and an outcome (or outcomes) of the actual response actions. The information can be used to generate updated training data to retrain or update one or more of the speech recognition instructions 320, the data reduction models 322, the clustering instructions 324, the event classifiers 326, or the event response models 328. For example, based on data that is received from the data sources 302 well after the event (such as via updated news stories or social media posts), the computing device(s) 306 or a user may determine that the event classification data wrongly indicated that a bank robbery was a kidnapping. In this example, the digest data used to generate the initial event classification data can be used as labeled data by tagging the digest data as corresponding to a bank robbery and retraining one or more of the event classifiers based on the labeled data. As another example, the actual response actions taken and the resulting outcomes can be used with a reinforcement learning technique to update the event response models to improve future response recommendations.

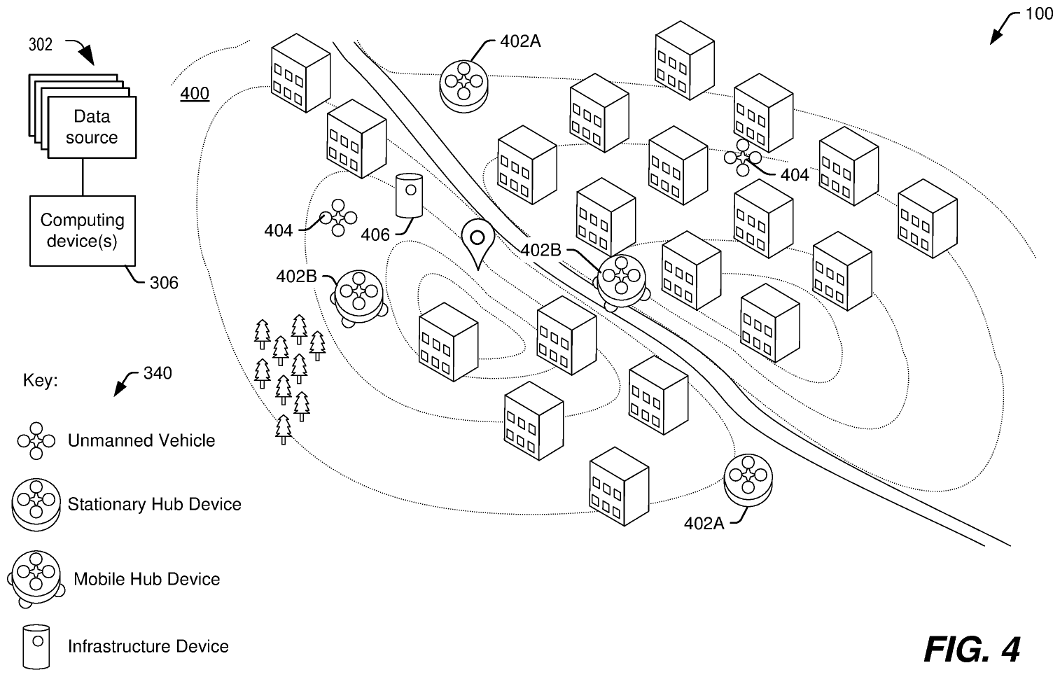

FIG. 4 illustrates a particular example of the system 100 in a geographic area 400. In FIG. 4, the system 100 includes the computing device(s) 306, the data sources 302, and several examples of the unmanned device 340 of FIG. 3. In FIG. 4, the examples of the unmanned device 340 include one more stationary hub devices 402A, one or more mobile hub devices 402B, one or more unmanned vehicles 404, and/or one or more infrastructure device 406. Each hub device 402 is configured to store, deploy, maintain, and/or control one or more of the unmanned vehicles 404. In this context, unmanned vehicle 404 is used as a generic term to include unmanned aerial vehicles, unmanned land vehicles, unmanned water vehicles, unmanned submersible vehicles, or combinations thereof. An unmanned vehicle 404 can be configured to gather data, to transport cargo (e.g., event response supplies), to manipulate objects in the environment, or combinations thereof, to perform a task.

The infrastructure devices 406 can include sensors (e.g., one or more of the sensors 110 of FIG. 1), communication equipment, data processing and/or storage equipment, other components, or a combination thereof. For example, a particular infrastructure device 406 can include a closed-circuit security camera (e.g., one of the cameras 104 of FIG. 1) that provides video of a portion of the geographic region 400. In this example, the video can be used by the system 100 to detect an event or to estimate the likelihood of occurrence of an event (e.g. a traffic delay, gathering of an unruly crowd, etc.) in the portion of the geographic region 400 (or in a nearby portion of the geographic region) and can cause appropriate response actions to be taken by components of the system 100. To illustrate, if the system 100 determines that an unruly crowd has gathered in a particular zone of the geographic region 400 monitored by the particular infrastructure device 406, and that the unruly crowd is moving toward an adjacent zone of the geographic region 400, the system 100 can cause a mobile hub device 402B that includes riot control unmanned vehicles 404 (i.e., unmanned vehicles 404 equipped to perform various riot control tasks) to be dispatched to the adjacent zone in preparation for possible deployment of the riot control unmanned vehicles 404.

In some implementations, each hub device 402 includes several different types of unmanned vehicles 404, and each unmanned vehicle 404 is associated with a set of capabilities. In such implementations, the hub device 402 can store inventory data (e.g., the resource availability data 134 of FIG. 1) indicating capabilities of each unmanned vehicle 404 in the hub device's inventory. To illustrate, in the previous example, the mobile hub device 402B deployed to the adjacent zone can include inventory data indicating that several of the unmanned vehicles 404 stored at the mobile hub device 402B are in a ready state (e.g., have sufficient fuel or a sufficient battery charge level, have no fault conditions that would limit or prevent operation, etc.), have equipment that would be helpful for riot control (e.g., a tear gas dispenser, a loud speaker, a wide angle camera, etc.), have movement capabilities (e.g., range, speed, off-road tires, maximum altitude) appropriate for use in the adjacent zone, etc. The mobile hub device 402B can also be dispatched to the adjacent zone based on a determination that the mobile hub device 402B itself (as distinct from the unmanned vehicles 404 of the mobile hub device 402B) is ready and able to operate in the adjacent zone. To illustrate, if the adjacent zone is flooded, the mobile hub device 402B can be capable of operating in the adjacent zone if it is water-resistant but may not be capable of operating in the adjacent zone if it is not water-resistant.

In addition to mobile hub device 402B, the system 100 can include one or more stationary hub devices 402A. The stationary hub devices 402A can include the same components and can operate in the same manner as mobile hub devices 402B, except that the stationary hub devices 402A maintain a fixed position unless relocated by a person or another device. In some implementations, stationary hub devices 402A can be used in portions of the geographic region 400 with a relatively high response rate (e.g., in zones where the system 100 frequently performs tasks), in high risk areas (e.g., locations where a guard post might ordinarily be located, such as gates or doors to high security areas), in other locations, or in combinations thereof. In some implementations, a stationary hub device 402A can be positioned to facilitate operation of the mobile hub devices 402B. To illustrate, a stationary hub device 402A can be centrally located in the geographic region 400 to act as a relay station or recharging/refueling station for unmanned vehicles 404 moving from one mobile hub device 402B to another mobile hub device 402B.

In some implementations, one or more of the infrastructure devices 406 are also stationary hub devices 402A. For example, a stationary hub device 402A can include sensors, communication equipment, data processing and/or storage equipment, other components, or a combination thereof.

In some implementations, the unmanned vehicles 404 can operate independently or as a group (e.g., a swarm). Further, at least some of the unmanned vehicles 404 are interchangeable among the hub devices 402. For example, an unmanned vehicle 404 can move from one hub device 402 to another hub device 402. To illustrate, if an unmanned vehicle 404 is assigned to perform a task and performance of the task will not allow the unmanned vehicle 404 to return to the hub device 402 that dispatched the unmanned vehicle 404, the unmanned vehicle 404 can dock at another hub device 402 to refuel or recharge, to re-equip (e.g., reload armaments), to download data, etc. In such implementations, the unmanned vehicle 404 can be added to the inventory of the hub device 402 at which it docked and can be removed from the inventory of the hub device 402 that deployed it. This capability enables the hub devices 402 to exchange unmanned vehicles 404 to accomplish particular objectives. To illustrate, unmanned vehicles 404 that are equipped with dangerous equipment, such as weapons systems, can be stored at a stationary hub device 402A and are only deployed to mobile hub devices 402B when needed or after discharge of the dangerous equipment (e.g., when armament has been expended). In this illustrative example, reinforced and secure systems to protect the dangerous equipment from unauthorized access can be heavy and expensive. Accordingly, it may be less expensive and more secure to store the dangerous equipment at the stationary hub device 402A than to attempt to ensure the security and tamper-resistance of a mobile hub device 402B.

In some implementations, a group of unmanned vehicles 404 can be controlled by a hub device 402. In other implementations, a group of unmanned vehicles 404 can be controlled by one unmanned vehicle 404 of the group as a coordination and control vehicle. The coordination and control vehicle can be dynamically selected or designated from among the group of unmanned vehicles 404 as needed. For example, a hub device 402 that is deploying the group of unmanned vehicles 404 can initially assign a first unmanned vehicle 404 as the coordination and control vehicle for the group based on the first unmanned vehicle 404 having an operating altitude that enables the first unmanned vehicle 404 to take up an overwatch position for the group. However, in this example, if the first unmanned vehicle 404 becomes incapacitated, is retasked, or is out of communications, another coordination and control vehicle is selected.

Designation of a coordination and control vehicle can be on a volunteer basis or by voting. To illustrate a volunteer example, when an unmanned vehicle 404 determines a coordination and control vehicle needs to be designated (e.g., because a heart-beat signal has not been received from the previous coordination and control vehicle within an expected time limit), the unmanned vehicle 404 can transmit a message to the group indicating that the unmanned vehicle 404 is taking over as the coordination and control vehicle. In an alternative volunteer example, the unmanned vehicle 404 that determines that a coordination and control vehicle needs to be designated can send a message to the group requesting that each member of the group send status information to the group, and an unmanned vehicle 404 that has the most appropriate status information among those reporting status information can take over as the coordination and control vehicle. To illustrate a voting example, when an unmanned vehicle 404 determines a coordination and control vehicle needs to be designated, the unmanned vehicle 404 can send a message to the group requesting that each member of the group send status information to the group, and the group can vote to designate the coordination and control vehicle based on reported status information.

Various machine learning techniques can be used to generate decision models used by the hub devices 402 (or the computing device(s) 306) to enable the system 100 to autonomously or cooperatively identify events, classify the events, identify task(s) to be performed, dispatch mobile hub devices 402B, dispatch unmanned vehicles 404, or combinations thereof. For example, the computing device(s) 306 can include or correspond to one or more of the hub devices 402, and the hub devices 402 can include one or more decision models, which can be trained machine learning models. In this example, a trained machine learning model can include a reinforcement learning model, a natural language processing model, a trained classifier, a regression model, etc. As a specific example, an unmanned vehicle 404 can be trained to perform a specific task, such as surveilling a crowd or deploying a weapon, by using reinforcement learning techniques. In this example, data can be gathered while an expert remote vehicle operator performs the specific task, and the data gathered while the expert performs the specific task can be used as a basis for training the unmanned vehicle to perform the specific task. As another example, video, audio, radio communications, or combinations thereof, from a monitored area can be used to train a risk assessment model to estimate the risk of particular types of events within a monitored area. As another example, task simulations can be used to train a mission planning model to make decisions about mission planning, can be used to train a cost-benefit model to make decisions related to equipment expenditures and equipment recovery, can be used to train a vehicle selection model to optimize selection of unmanned vehicles 404 assigned to particular task, etc.

Accordingly, devices (e.g., the computing device(s) 306, the hub devices 402, and/or the unmanned vehicles 404) of the system 100 are able to operate cooperatively or autonomously to perform one or more tasks. While a human can intervene, in some implementations, the system 100 can operate without human intervention. The system 100 may be especially beneficial for use in circumstances or locations in which human action would be difficult or dangerous. For example, in high risk crime areas, it can be expensive and risky to significantly increase police presence. The system 100 can be used in such areas to gather information, to provide initial risk assessments, to respond to risk or an event, etc. In the example of a high-risk crime area, one or more stationary hub devices 402A can be pre-positioned and one or more mobile hub devices 402B can be provided as backup to move into particular regions where response from the stationary hub devices 402A may be difficult.

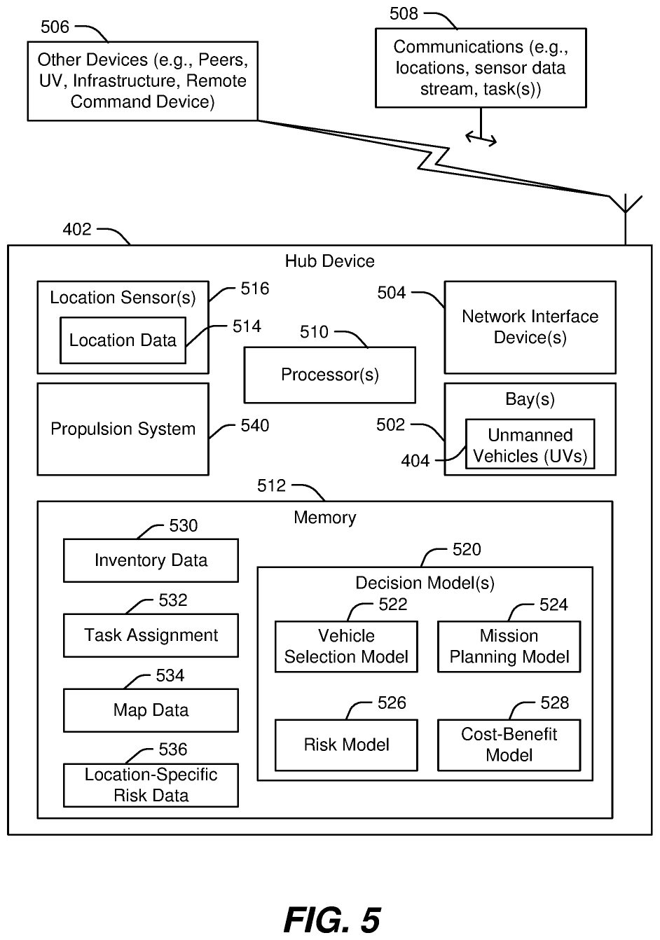

FIG. 5 is a block diagram of a particular example of a hub device 402. The hub device 402 of FIG. 5 may be a stationary hub device 402A or a mobile hub device 402B of FIG. 1. The hub device 402 is configured to dispatch unmanned vehicles 404. For example, the hub device 402 includes one or more bays 502 for storage of a plurality of unmanned vehicles 404. In a particular implementation, each bay 502 is configured to store a single unmanned vehicle 404. In other implementations, a single bay 502 can store more than one unmanned vehicle 404. In some implementations, a bay 502 includes equipment and connections to refuel or recharge an unmanned vehicle 404, to reconfigure or re-equip (e.g., re-arm) the unmanned vehicle 404, to perform some types of maintenance on the unmanned vehicle 404, or combinations thereof. The bay(s) 502 can also be configured to shelter the unmanned vehicles 404 from environmental conditions and to secure the unmanned vehicles 404 to inhibit unauthorized access to the unmanned vehicles 404.

The hub device 402 also includes one or more network interface devices 504. The network interface device(s) 504 are configured to communicate with other peer hub devices 506, to communicate 508 with the unmanned vehicles 404 of the hub device 402, to communicate 508 with unmanned vehicles 404 deployed by peer hub devices, to communicate with infrastructure devices 406, to communicate with a remote command device, or combinations thereof. The network interface device(s) 504 may be configured to use wired communications, wireless communications, or both. For example, the network interface device(s) 504 of a mobile hub device 402B can include one or more wireless transmitters, one or more wireless receivers, or a combination thereof (e.g., one or more wireless transceivers) to communicate with the other devices. As another example, the network interface device(s) 504 of a stationary hub device 402A can include a combination of wired and wireless devices, including one or more wireless transmitters, one or more wireless receivers, one or more wireless transceivers, one or more wired transmitters, one or more wired receivers, one or more wired transceivers, or combinations thereof, to communicate with the other devices. To illustrate, the stationary hub device 402A can communicate with other stationary devices (e.g., infrastructure devices 406) via wired connections and can communicate with mobile device (e.g., unmanned vehicles 404 and mobile hub devices 402B) via wireless connections. The network interface device(s) 504 can be used to communicate location data 514 (e.g., peer location data associated with one or more peer hub devices), sensor data (e.g., a sensor data stream, such as a video or audio stream), task data, commands to unmanned vehicles 404, etc.

The hub device 402 also includes a memory 512 and one or more processors 510. The memory 512 can include volatile memory devices, non-volatile memory devices, or both. The memory 512 stores data and instructions (e.g., computer code) that are executable by the processor(s) 510. For example, the instructions can include one or more decisions models 520 (e.g., trained machine learning models) that are executable by the processor(s) 510 to initiate, perform, or control various operations of the hub device 402. Examples of specific decision models that can be stored in the memory 512 and used to perform operations of the hub device 402 are described further below.

Examples of data that can be stored in the memory 512 include inventory data 530, map data 534, location-specific risk data 536, task assignment data 532, and location data 514. In FIG. 5, the location data 514 indicates the location of the hub device 402. For example, if the hub device 402 is a mobile hub device 402B, the location data 514 can be determined by one or more location sensors 516, such as a global positioning system receiver, a local positioning system sensor, a dead-reckoning sensor, etc. If the hub device 402 is a stationary hub device 402A, the location data 514 can be preprogrammed in the memory 512 or can be determined by one or more location sensors 516. The location data 514 can also include peer location data indicating the locations of peer devices (e.g., peer hub devices, infrastructure devices, unmanned vehicles, or a combination thereof). The locations of the peer devices can be received via the network interface device(s) 504 or, in the case of stationary peer devices 402A, can be preprogrammed in the memory 512.

The map data 534 represents a particular geographic region that includes a location of the hub device 402 and locations of the one or more peer hub devices. The map data 534 can also indicate features of the geographic region, such as locations and dimensions of buildings, roadway information, terrain descriptions, zone designations, etc. To illustrate, the geographic region can be logically divided into zones and the location of each zone can be indicated in the map data 534.

The inventory data 530 includes information identifying unmanned vehicles 404 stored in the bays 502 of the hub device 402. In some implementations, the inventory data 530 can also include information identifying unmanned vehicles 404 that were deployed by the hub device 402 and that have not been transferred to another peer hub device or lost. The inventory data 530 can also include information indicative of capabilities of each of the unmanned vehicles 404. Examples of information indicative of capabilities of an unmanned vehicle 404 such as a load out of the unmanned vehicle 404, a health indicator of the unmanned vehicle 404, state of charge or fuel level of the unmanned vehicle 404, an equipment configuration of the unmanned vehicle 404, operational limits associated with the unmanned vehicle 404, etc. As another example, the information indicative of the capabilities of the unmanned vehicle 404 can include a readiness value. In this example, the processor(s) 510 can assign a readiness value (e.g., a numeric value, an alphanumeric value, or a logical value (e.g., a Boolean value)) to each unmanned vehicle 404 in the inventory data 530 and can use the readiness value to prioritize use and deployment of the unmanned vehicles 404 based on the readiness values. A readiness value can be assigned to a particular unmanned vehicle 404 based on, for example, a battery charge state of the particular unmanned vehicle 404, a fault status indicating in a vehicle health log of the particular unmanned vehicle 404, other status information associated with the particular unmanned vehicle 404, or a combination thereof.

The task assignment data 532 indicates a task assignment associated with the hub device 402 or with multiple hub devices 402. For example, a remote command device (e.g., one of the computing device(s) 306) can send a task assignment to the hub device 402 or to multiple hub devices 402. The task assignment can specify one or more tasks (e.g., move an item from point A to point B) or can specify a goal or objective. In some implementations, the task assignment can include a natural language statement (e.g., an unstructured command), in which case the processor(s) can use a natural language processing model to evaluate the task assignment to identify the goal, objective, and/or task specified. If a goal or objective is specified, the processor(s) 510 can be used to execute one or more of the decision models 520 to evaluate the goal or objective and determine one or more tasks (e.g., specific operations or activities) to be performed to accomplish the goal or objective. To illustrate, if the objective is to monitor a zone for dangerous conditions, the processor(s) 510, executing the decision model 520, may determine that the objective can be accomplished by using a risk model 526 to evaluate video data documenting conditions over a significant percentage (e.g., 70%) of the zone and that three of the available unmanned vehicles can be deployed to specific locations to gather the video data.

The location-specific risk data 536 indicates historical or real-time risk values for particular types of events. The location-specific risk data 536 can be generated in advance, e.g., based on expert analysis of historical data, and stored in the memory 512 for use in risk analysis and cost-benefit analysis. Alternatively, the location-specific risk data 536 can be generated by a trained machine learning model, e.g., a location-specific risk model, in which case the location-specific risk data 536 can be based on an analysis of real-time or near real-time data.

As explained above, the decision models 520 on-board the hub device 402 can include one or more trained machine learning models that are trained to make particular decisions, to optimize particular parameters, to generate predictions or estimates, or combinations thereof. In the example illustrated in FIG. 5, the decision models 520 include a risk model 526 (e.g. the location-specific risk model), a vehicle selection model 522, a mission planning model 524, and a cost-benefit model 528. In other examples, the decision models 520 can include additional decision models, fewer decision models, or different decision models.

The vehicle selection model 522 is executable by the processor(s) 510 to evaluate the inventory data 530, task assignment data 532, the map data 534, and the location data 514, to assign one or more unmanned vehicles 404 of the plurality of unmanned vehicles 404 to perform a task of a task assignment. For example, the vehicle selection model 522 can select an unmanned vehicle 404 that has equipment capable of performing the task and that has sufficient fuel or battery charge, and that has particular other characteristics (e.g., flight range, off-road tires, etc.) to accomplish the task. In some implementations, the vehicle selection model 522 can also select the unmanned vehicle 404 based on other information, such as the peer location data. For example, a particular task may require flight with the wind (e.g., in a tail wind) to a particular location, where no available unmanned vehicle has sufficient power reserves to fly to the particular location and to subsequently return into the wind (e.g., in a head wind). In this example, the vehicle selection model 522 can select an unmanned vehicle 404 that is capable of flying to the particular location with the tail wind and subsequently to fly to the particular location of a peer device that is downwind from the particular location. After the vehicle selection model 522 selects the one or more unmanned vehicles 404 to perform the task, the hub device 402 assigns the one or more unmanned vehicles 404 to the task by storing information (e.g., in the inventory data 530) indicating that the one or more unmanned vehicles 404 are occupied, instructing the one or more unmanned vehicles 404, and deploying the one or more unmanned vehicles 404.

In some implementations, the vehicle selection model 522 selects a particular unmanned vehicle 404 based at least in part on a cost-benefit analysis by the cost-benefit model 528. The cost-benefit model 528 is configured to consider a priority assigned to the task (e.g., how important is successful accomplishment of this specific task to accomplishment of an overall goal or objective), a likelihood of the particular unmanned vehicle 404 accomplishing the task, and a likelihood of retrieval of the particular unmanned vehicle 404. For example, in a particular circumstance, the task is low priority (e.g., has an assigned priority value that is relatively low compared to other tasks the system 100 is performing) and the likelihood of retrieving the unmanned vehicle 404 after the task is performed is low. In this circumstance, the cost-benefit model 528 may suggest using a cheaper or less strategically important unmanned vehicle 404 that, due to its capabilities, is less likely to achieve the task than a more expensive or more strategically important unmanned vehicle 404. The cost-benefit model 528 can be tuned based on specific values or priorities of an organization operating the system 100.

In a particular implementation, the mission planning model 524 is configured to generate one or more task route plans. A task route plan indicates a particular end-to-end path that an unmanned vehicle 404 can follow during performance of a task. In some implementations, the task route plan is dynamic. For example, an unmanned vehicle 404 can initially (e.g. upon deployment) be given a task route path by a hub device 402, and the hub device 402 or the unmanned vehicle 404 can modify the task route plan based on intrinsic or extrinsic factors. Examples of such extrinsic factors include environmental conditions (e.g. weather), changing priorities, an updated risk assessment, updated task assignments, changed positions of other devices in the system 100, etc. Examples of such intrinsic factors include occurrence of fault conditions or equipment malfunctions. In some implementations, the mission planning model 524 can generate a plurality of task route plans, where each of the task route plans indicates a possible route that an unmanned vehicle 404 could follow to perform the task. In such implementations, the mission planning model 524 can also generate a set of estimated capabilities of the unmanned vehicle 404 to be able to perform the task, to be recoverable after performance of the task, or both. The mission planning model 524 can provide the set of estimated capabilities to the vehicle selection model 522, and the vehicle selection model 522 can select the one or more unmanned vehicles 404 to assign to a task based in part on the set of estimated capabilities.

In implementations in which the hub device 402 is a mobile hub device 402B, the hub device 402 also includes a propulsion system 540. The propulsion system 540 includes hardware to cause motion of the mobile hub device 402B via land, air, and/or water. The mobile hub device 402B can also include components and software to enable the mobile hub device 402B to determine its current location and to select a new location (e.g., a dispatch location). For example, the mobile hub device 402B can include a decision model 520 that is executable by the processor(s) 510 to evaluate the task assignment data 532, the location-specific risk data 536, the map data 534, the location data 514, or a combination thereof, and to generate an output indicating dispatch coordinates. In this example, the dispatch coordinates identifying a dispatch location from which to dispatch one or more unmanned vehicles 404 of the plurality of unmanned vehicles to perform a task indicated by the task assignment.

In a particular implementation, the dispatch location is specified as a range, such as the dispatch coordinates and a threshold distance around the dispatch location or as a geofenced area. In response to determining that the current location of the mobile hub device 402B is not within the dispatch location (e.g., is further than the threshold distance from the dispatch coordinates), the processor(s) 510 control the propulsion system 540 based on the location data 514 and the map data 534 to move the mobile hub device 402B to the dispatch location (e.g., within a threshold distance of the dispatch coordinates). For example, the processor(s) can use the map data 534, the location data 514, and the dispatch coordinates, to determine a travel path to move the mobile hub device 402B to the dispatch location based on mobility characteristics of the mobile hub device 402B. To illustrate, if the mobile hub device 402B is capable of operating in water, the travel path can include a path across a lake or stream; however, if the mobile hub device 402B is not capable of operating in water, the travel path can avoid the lake or stream.

In some implementations, the threshold distance around the dispatch coordinates is determined based on an operational capability of the unmanned vehicles 404 and locations of other mobile hub devices 402B. For example, the dispatch coordinates can indicate an optimum or idealized location for dispatching the unmanned vehicles 404; however, for various reasons, the mobile hub device 402B may not be able to access or move to the dispatch coordinates. To illustrate, the dispatch coordinates can be in a lake and the mobile hub device 402B may be incapable of operating in water. As another illustrative example, a barrier, such as a fence, can be between the mobile hub device 402B and the dispatch coordinates. If other hub devices 402 are nearby and can receive the unmanned vehicle 404, the threshold distance can be set based on a maximum one-way range of the unmanned vehicle 404 minus a safety factor and a range adjustment associated with performing the task. If no other hub device 402 is nearby that can receive the unmanned vehicle 404, the threshold distance can be set based on a maximum round trip range of the unmanned vehicle 404 minus a safety factor and a range adjustment associated with performing the task. The mobile hub device 402B can receive deployment location data associated with one or more other mobile hub devices 402B (or other peer devices) via the network interface device(s) 504 and determine the dispatch coordinates, the distance threshold, or both, based on the deployment location data.

In some implementations, the dispatch coordinates are determined responsive to a determination that the one or more unmanned vehicles 404 of the mobile hub device 402B are capable of performing the task. For example, the decision model 520 can compare the task to the inventory data 530 to determine whether any unmanned vehicle 404 on-board the mobile hub device 402B is capable of performing the task. If no unmanned vehicle 404 on-board the mobile hub device 402B is capable of performing the task, the decision model 520 can bypass or omit the process of determining the dispatch coordinates.

In some implementations, the mobile hub device 402B can be preemptively (or predictively) deployed to a dispatch location based on a forecasted need. To illustrate, the risk model 526 can generate location-specific risk data 536 that indicates an estimated likelihood of a particular type of event occurring within a target geographic region. For example, the risk model 526 can evaluate real-time or near real-time status data for one or more zones within the particular geographic region and can generate the location-specific risk data 536 based on the real-time or near real-time status data. In this example, the location-specific risk data 536 can indicate a likelihood of a particular type of event (e.g., a wild fire, a riot, an intrusion) occurring within one or more zones of the plurality of zones.

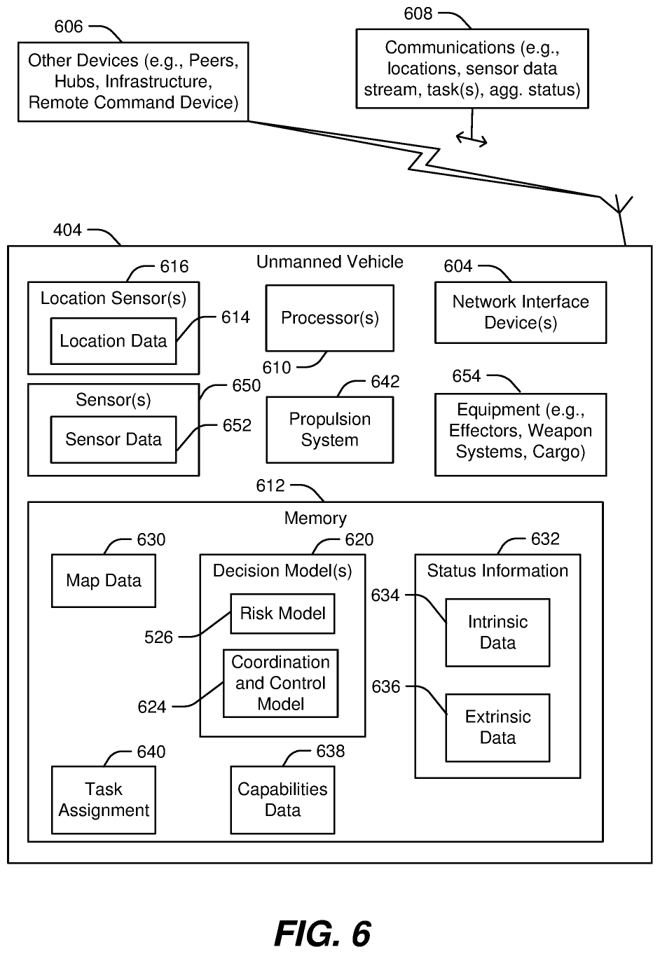

FIG. 6 is a block diagram of a particular example of an unmanned vehicle 404. The unmanned vehicle 404 includes or corresponds to an unmanned aerial vehicle (UAV), an unmanned combat aerial vehicle (UCAV), an unmanned ground vehicle (UGV), an unmanned water vehicle (UWV), or an unmanned hybrid vehicle (UHV) that can operate in more than one domain, such as in air and in water.

In some implementations, the unmanned vehicle 404 is configured to interact with a hub device 402. For example, the unmanned vehicle 404 may be configured to be storable in a bay 502 of a hub device 402 of FIG. 5. In such implementations, the unmanned vehicle 404 includes connections to refuel or recharge via the hub device 402, to be reconfigured or re-equipped (e.g., re-armed) via the hub device 402, to be maintained by the hub device 402, or combinations thereof.

The unmanned vehicle 404 includes one or more network interface devices 604, a memory 612, and one or more processors 610. The network interface device(s) 604 are configured communicate with hub devices 402, to communicate with peer unmanned vehicles 404, to communicate with infrastructure devices 406, to communicate with a remote command device, or combinations thereof. The network interface device(s) 604 are configured to use wired communications 608, wireless communications 608, or both. For example, the network interface device(s) 604 of an unmanned vehicle 404 can include one or more wireless transmitters, one or more wireless receivers, or a combination thereof (e.g., one or more wireless transceivers) to communicate with the other devices 606. As another example, the network interface device(s) 604 of the unmanned vehicle 404 can include a wired interface to connect to a hub device when the unmanned vehicle 404 is disposed within a bay 502 of the hub device 402.

The memory 612 can include volatile memory devices, non-volatile memory devices, or both. The memory 612 stores data and instructions (e.g., computer code) that are executable by the processor(s) 610. For example, the instructions can include one or more decisions models 620 (e.g., trained machine learning models) that are executable by the processor(s) 610 to initiate, perform, or control various operations of the unmanned vehicle 404. Examples of specific decision models 620 that can be stored in the memory 612 and used to perform operations of the unmanned vehicle 404 are described further below.

Examples of data that can be stored in the memory 612 include map data 630, task assignment data 640, intrinsic data 634, extrinsic data 636, and location data 614. In some implementations, some or all of the data associated with the hub device of FIG. 5, some or all of the decision models 620 associated with the hub device of FIG. 5, or combinations thereof, can be stored in the memory 612 of the unmanned vehicle 404 (or distributed across the memory 612 of several unmanned vehicles 404). For example, the memory 512 of the hub device 402 of FIG. 5 can be integrated with one or more of the unmanned vehicles 404 in the bays 502 of the hub device 402. In this example, the hub device 402 is a “dumb” device or a peer device to the unmanned vehicles 404 and the unmanned vehicles 404 control the hub device 402.

In FIG. 6, the location data 614 indicates the location of the unmanned vehicle 404. For example, the location data 614 can be determined by one or more location sensors 616, such as a global positioning system receiver, a local positioning system sensor, a dead-reckoning sensor, etc. The location data 614 can also include peer location data indicating the locations of peer devices (e.g., hub devices 402, infrastructure devices 406, other unmanned vehicles 404, or a combination thereof). The locations of the peer devices can be received via the network interface device(s) 604.

The unmanned vehicle 404 also includes one or more sensors 650 configured to generate sensor data 652. The sensors 650 can include cameras, ranging sensors (e.g., radar or lidar), acoustic sensors (e.g., microphones or hydrophones), other types of sensors, or any combination thereof. In some circumstances, the unmanned vehicle 404 can use the sensors 650 to perform a task. For example, the task can include capturing video data for a particular area, in which case a camera of the sensors 650 is primary equipment to achieve the task. In other circumstances, the sensors 650 can be secondary equipment that facilitates achieving the task. For example, the task can include dispensing tear gas within a region, in which case the sensors 650 may be used for aiming a tear gas dispenser to avoid bystanders.

The unmanned vehicle 404 can also include other equipment 654 to perform or assist with performance of a task. Examples of other equipment 654 can include effectors or manipulators (e.g., to pick up, move, or modify objects), weapons systems, cargo related devices (e.g., devices to acquire, retain, or release cargo), etc. In some implementations, equipment of the unmanned vehicle 404 can use consumables, such as ammunition, the availability of which can be monitored by the sensors 650.

The unmanned vehicle 404 also includes a propulsion system 642. The propulsion system 642 includes hardware to cause motion of the unmanned vehicle 404 via land, air, and/or water. The unmanned vehicle 404 can also include components and software to enable the unmanned vehicle 404 to determine its current location and to select and navigate to a target location.

In FIG. 6, the memory 612 of the unmanned vehicle 404 includes capabilities data 638 for the unmanned vehicle 404. The capabilities data 638 can be used by the decision models 620 on-board the unmanned vehicle 404 to make risk assessments, for mission planning, etc. In some implementations, the capabilities data 638 can be provided to other devices 606 of the system 100 as well. To illustrate, if the unmanned vehicle 404 of FIG. 6 is part of a swarm (e.g., a group of unmanned vehicles 404 that are coordinating to perform a task), the unmanned vehicle 404 can provide some or all of the capabilities data 638 to other vehicles of the swarm or to a coordination and control vehicle of the swarm. As another illustrative example, the unmanned vehicle 404 can provide some or all of the capabilities data 638 to a hub device 402, such as when the unmanned vehicle 404 is added to an inventory of the hub device 402.

The capabilities data 638 includes parameters, functions, or tables with data that is relevant to determining the ability of the unmanned vehicle 404 to perform particular tasks. Examples of capabilities data 638 that can be determined or known for each unmanned vehicle 404 include range, operational time, mode(s) of travel (e.g., air, land, or water), fuel or charging requirements, launch/recovery requirements, on-board decision models 620, communications characteristics, equipment load out (e.g., what equipment is on-board the unmanned vehicle 404), equipment compatibility (e.g., what additional equipment can be added to the unmanned vehicle 404 or what equipment interfaces are on-board the unmanned vehicle 404), other parameters, or combinations thereof. Some of the capabilities can be described as functions (or look-up tables) rather than single values. To illustrate, the range of the unmanned vehicle 404 can vary depending on the equipment on-board the unmanned vehicle 404, the state of charge or fuel level of the unmanned vehicle 404, and the environmental conditions (e.g., wind speed and direction) in which the unmanned vehicle 404 will operate. Thus, rather than having a single range value, the range of the unmanned vehicle 404 can be a function that accounts for equipment, state of charge/fuel level, environmental conditions, etc. to determine or estimate the range. Alternatively, a look-up table or set of look-up tables can be used to determine or estimate the range.

Some portions of the capabilities data 638 are static during operations of the unmanned vehicle 404. For example, the mode(s) of travel of the unmanned vehicle 404 can be static during normal operation of the unmanned vehicle 404 (although this capability can be updated based on reconfiguration of the unmanned vehicle 404). Other portions of the capabilities data 638 are updated or modified during normal operation of the unmanned vehicle 404. For example, the fuel level or charge state can be monitored and updated periodically or occasionally. In some implementations, the capabilities data 638 is updated based on or determined in part based on status information 632. The status information 632 can include intrinsic data 634 (i.e., information about the unmanned vehicle and its on-board equipment and components) and extrinsic data 636 (i.e., information about anything that is not a component of or on-board the unmanned vehicle 404). Examples of intrinsic data 634 include load out, health, charge, equipment configuration, etc. Examples of extrinsic data 636 include location, status of prior assigned tasks, ambient environmental conditions, etc. In some implementations, the value of particular capabilities parameter can be determined by one of the decision models 620. For example, a trained machine learning model can be used to estimate the range or payload capacity of the unmanned vehicle 404 based on the intrinsic data 634 and the extrinsic data 636.

In a particular implementation, the unmanned vehicle 404 is configured to interact with other peer devices, such as other unmanned vehicles 404, hub devices 402, and/or infrastructure devices 406 as an autonomous swarm that includes a group of devices (e.g., a group of unmanned vehicles 404). In such implementations, when operating as a swarm, the group of devices can dynamically select a particular peer device as a lead device. To illustrate, if a group of unmanned vehicles 404 are dispatched to perform a task, the group of unmanned vehicles 404 can dynamically select one unmanned vehicle 404 of the group as a coordination and control vehicle. The decision models 620 can include a coordination and control model 624 that is executable by the processor 610 to perform the tasks associated with coordination and control of the group of devices (e.g., the swarm), to select a coordination and control device, or both.

Depending on the mission or the configuration of the system 100, the coordination and control device (e.g., a device executing the coordination and control model 624) can operate in either of two modes. In a first mode of operation, the coordination and control device acts solely in a coordination role. For example, the coordination and control device relays task data from remote devices (e.g., a remote command device) to peer devices of the group. As another example, the coordination and control device, operating in the coordination role, can receive status information 632 from peer devices of the group, generate aggregate status information for the group based on the status information 632, and transmit the aggregate status information 632 to a remote command device. When the coordination and control device is operating in the coordination role, the peer devices of the group can operate autonomously and cooperatively to perform a task. For example, a decision about sub-tasks to be performed by an unmanned vehicle 404 of the group can be determined independently by the unmanned vehicle 404 and can be communicated to the group, if coordination with the group is needed. As another example, such decisions can be determined in a distributed fashion by the group, e.g., using a voting process.

In a second mode of operation, the coordination and control device acts both in a coordination role and in a control role. The coordination role is the same as described above. In the control role, sub-tasks are assigned to members of the group by the coordination and control device. Thus, in the second mode of operation, the coordination and control device behaves like a local commander for the group in addition to relaying information to the remote command device and receive updated task assignments from the remote command device. In some implementations, the swarm can also operate when no communication is available with the remote command device. In such implementations, the coordination and control device can operate in the command mode or decisions can be made among the unmanned vehicles 404 individually or in a distributed manner, as described above. In some implementations, regardless of the operating mode of the coordination and control vehicle, communications among the peer devices of a group can be sent via an ad hoc mesh network. In other implementations, the communications among the peer devices are sent via a structured network, such as hub-and-spoke network with the coordination and control device acting as the hub of the network.

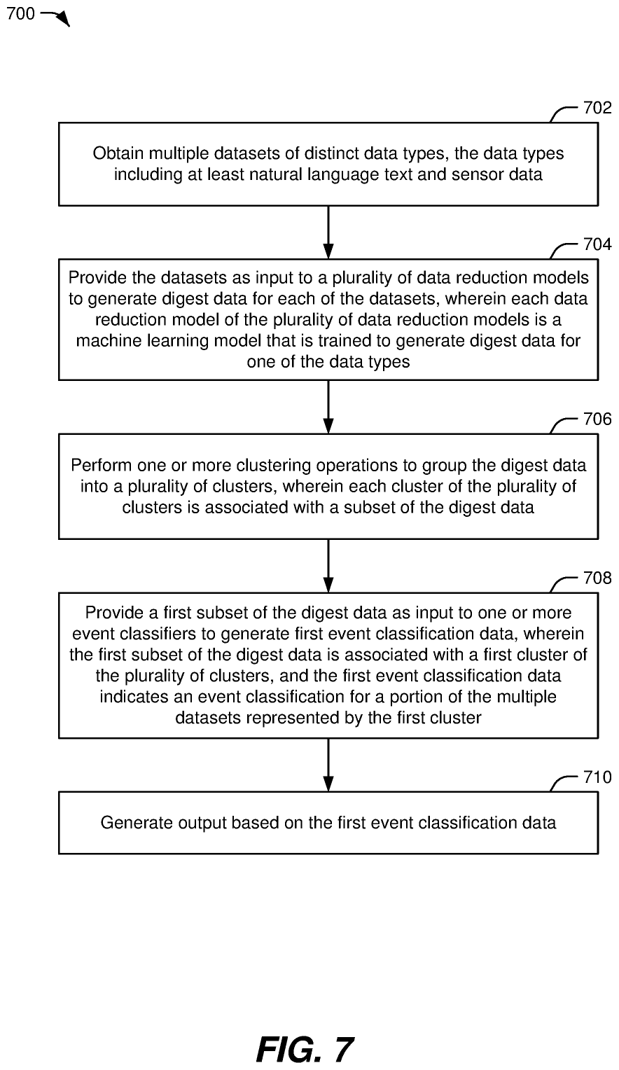

FIG. 7 is a flow chart of a particular example of a method 700 that may be initiated, controlled, or performed by the system 100 of FIGS. 1-4. For example, the method 700 can be performed by the processor(s) 312 responsive to execution of a set of instructions.

The method 700 includes, at 702, obtaining multiple datasets of distinct data types, structured and unstructured. For example, the data types may include natural language text, sensor data, image data, video data, audio data, or other data, or combinations thereof. In some implementations, the method 700 includes receiving audio data and generating a transcript of the audio data. In such implementations, the transcript of the audio data includes natural language text that corresponds to one of the datasets. In some implementations, natural language text or other data types can be obtained from content of one or more social media posts, moderated media content (e.g., broadcast or internet news content), government sources, other data sources, or combinations thereof.

The method 700 further includes, at 704, providing the datasets as input to a plurality of data reduction models to generate digest data for each of the datasets. Each data reduction model of the plurality of data reduction models is a machine learning model that is trained to generate digest data for one of the data types. For example, the data reduction models can include one or more classifiers (e.g., neural networks, decision trees, etc.) that generate descriptors of the datasets. To illustrate, one of the data reduction models may include a face recognition model that generates output indicating a name of a person recognized in an image of one of the datasets. The digest data can include, for example, time information and location information associated with at least one dataset of the multiple datasets, one or more keywords or one or more descriptors associated with at least one dataset of the multiple datasets, one or more features associated with at least one dataset of the multiple datasets, or any combination thereof.

The method 700 also includes, at 706, performing one or more clustering operations to group the digest data into a plurality of clusters. Each cluster of the plurality of clusters is associated with a subset of the digest data. For example, the datasets can include information about multiple events that are occurring (or have occurred). In this example, the clustering operations are performed in an attempt to identify groups of data (e.g., clusters) that are each associated with a single respective event. That is, each cluster should (but need not) include digest data associated with a single event.

The method 700 further includes, at 708, providing a first subset of the digest data as input to one or more event classifiers to generate first event classification data. The first subset of the digest data is associated with a first cluster of the plurality of clusters, and the first event classification data indicates an event classification for a portion of the multiple datasets represented by the first cluster. In some implementations, the first event classification data is determined based on the portion of the multiple datasets represented by the first cluster rather than or in addition to being determined based on the first subset of the digest data.

The method 700 also includes, at 710, generating output based on the first event classification data. For example, the output can include one or more of the alarms 138 or the recommendations 132 of FIG. 1. Additionally, or in the alternative, the output can include the command(s) 342 of FIG. 3.

In some implementations, after the first event classification data is generated, the method 700 also includes searching for additional data using keywords based on the digest data, based on the multiple datasets, or based on both, generating updated first event classification data based on the additional data, and updating the one or more event classifiers based on the updated first event classification data. For example, it is not always immediately clear how an event was responded to or what the outcome of the response was. Accordingly, the computing device(s) 306 can perform keyword searches based on the digest data or datasets 304 to gather later arriving information about an event, such as official police reports, news articles, post-event debriefing reports, etc. that can be by the automated model builder instructions 330 to update the data reduction models 322, the event classifier(s) 326, and/or the event response models 328.

In some implementations, the output is based on or indicates a recommended response and or triggers automatic action. In such implementations, the method 700 also includes determining the recommended response action based on the first event classification data. For example, one or more event response models 328 can be selected based on the first event classification data. In this example, the digest data, the portion of the multiple datasets represented by the first cluster, or both, are provided as input to the selected event response models 328 to generate the recommended response action. To illustrate, in some implementations, each of the one or more selected response models performs a response simulation for a particular type of event corresponding to the first event classification data based on a time and location associated with the portion of the multiple datasets represented by the first cluster. In such implementations, the recommended response action is determined based on results of the response simulations.

In implementations that recommend a response action, the method 700 can further include, after generating the recommended response action, obtaining response result data indicating one or more actions taken in response to an event corresponding to the first event classification data and indicating an outcome of the one or more actions and updating the one or more selected response models based on the response result data. For example, the one or more selected response models can be updated by the automated model builder instructions 330 using a reinforcement learning technique.

Referring to FIG. 8, a particular illustrative example of a system 800 executing the automated model builder instructions 330 of FIG. 3. The system 800, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the automated model builder instructions 330 include a genetic algorithm 810 and an optimization trainer 860. The optimization trainer 860 is, for example, a backpropagation trainer, a derivative free optimizer (DFO), an extreme learning machine (ELM), etc. In particular implementations, the genetic algorithm 810 is executed on a different device, processor (e.g., central processor unit (CPU), graphics processing unit (GPU) or other type of processor), processor core, and/or thread (e.g., hardware or software thread) than the optimization trainer 860. The genetic algorithm 810 and the optimization trainer 860 are executed cooperatively to automatically generate a machine learning data model (e.g., one of the data reduction models 322, the event classifiers 326, the event response models, the decision models 520, and/or the decision models 620 of FIGS. 3, 5 and 6 and referred to herein as “models” for ease of reference), such as a neural network or an autoencoder, based on the input data 802. The system 800 performs an automated model building process that enables users, including inexperienced users, to quickly and easily build highly accurate models based on a specified data set.

During configuration of the system 800, a user specifies the input data 802. In some implementations, the user can also specify one or more characteristics of models that can be generated. In such implementations, the system 800 constrains models processed by the genetic algorithm 810 to those that have the one or more specified characteristics. For example, the specified characteristics can constrain allowed model topologies (e.g., to include no more than a specified number of input nodes or output nodes, no more than a specified number of hidden layers, no recurrent loops, etc.). Constraining the characteristics of the models can reduce the computing resources (e.g., time, memory, processor cycles, etc.) needed to converge to a final model, can reduce the computing resources needed to use the model (e.g., by simplifying the model), or both.

The user can configure aspects of the genetic algorithm 810 via input to graphical user interfaces (GUIs). For example, the user may provide input to limit a number of epochs that will be executed by the genetic algorithm 810. Alternatively, the user may specify a time limit indicating an amount of time that the genetic algorithm 810 has to execute before outputting a final output model, and the genetic algorithm 810 may determine a number of epochs that will be executed based on the specified time limit. To illustrate, an initial epoch of the genetic algorithm 810 may be timed (e.g., using a hardware or software timer at the computing device executing the genetic algorithm 810), and a total number of epochs that are to be executed within the specified time limit may be determined accordingly. As another example, the user may constrain a number of models evaluated in each epoch, for example by constraining the size of an input set 820 of models and/or an output set 830 of models.

The genetic algorithm 810 represents a recursive search process. Consequently, each iteration of the search process (also called an epoch or generation of the genetic algorithm 810) has an input set 820 of models (also referred to herein as an input population) and an output set 830 of models (also referred to herein as an output population). The input set 820 and the output set 830 may each include a plurality of models, where each model includes data representative of a machine learning data model. For example, each model may specify a neural network or an autoencoder by at least an architecture, a series of activation functions, and connection weights. The architecture (also referred to herein as a topology) of a model includes a configuration of layers or nodes and connections therebetween. The models may also be specified to include other parameters, including but not limited to bias values/functions and aggregation functions.

For example, each model can be represented by a set of parameters and a set of hyperparameters. In this context, the hyperparameters of a model define the architecture of the model (e.g., the specific arrangement of layers or nodes and connections), and the parameters of the model refer to values that are learned or updated during optimization training of the model. For example, the parameters include or correspond to connection weights and biases.

In a particular implementation, a model is represented as a set of nodes and connections therebetween. In such implementations, the hyperparameters of the model include the data descriptive of each of the nodes, such as an activation function of each node, an aggregation function of each node, and data describing node pairs linked by corresponding connections. The activation function of a node is a step function, sine function, continuous or piecewise linear function, sigmoid function, hyperbolic tangent function, or another type of mathematical function that represents a threshold at which the node is activated. The aggregation function is a mathematical function that combines (e.g., sum, product, etc.) input signals to the node. An output of the aggregation function may be used as input to the activation function.

In another particular implementation, the model is represented on a layer-by-layer basis. For example, the hyperparameters define layers, and each layer includes layer data, such as a layer type and a node count. Examples of layer types include fully connected, long short-term memory (LSTM) layers, gated recurrent units (GRU) layers, and convolutional neural network (CNN) layers. In some implementations, all of the nodes of a particular layer use the same activation function and aggregation function. In such implementations, specifying the layer type and node count fully may describe the hyperparameters of each layer. In other implementations, the activation function and aggregation function of the nodes of a particular layer can be specified independently of the layer type of the layer. For example, in such implementations, one fully connected layer can use a sigmoid activation function and another fully connected layer (having the same layer type as the first fully connected layer) can use a tan h activation function. In such implementations, the hyperparameters of a layer include layer type, node count, activation function, and aggregation function. Further, a complete autoencoder is specified by specifying an order of layers and the hyperparameters of each layer of the autoencoder.

In a particular aspect, the genetic algorithm 810 may be configured to perform speciation. For example, the genetic algorithm 810 may be configured to cluster the models of the input set 820 into species based on “genetic distance” between the models. The genetic distance between two models may be measured or evaluated based on differences in nodes, activation functions, aggregation functions, connections, connection weights, layers, layer types, latent-space layers, encoders, decoders, etc. of the two models. In an illustrative example, the genetic algorithm 810 may be configured to serialize a model into a bit string. In this example, the genetic distance between models may be represented by the number of differing bits in the bit strings corresponding to the models. The bit strings corresponding to models may be referred to as “encodings” of the models.

After configuration, the genetic algorithm 810 may begin execution based on the input data 802. Parameters of the genetic algorithm 810 may include but are not limited to, mutation parameter(s), a maximum number of epochs the genetic algorithm 810 will be executed, a termination condition (e.g., a threshold fitness value that results in termination of the genetic algorithm 810 even if the maximum number of generations has not been reached), whether parallelization of model testing or fitness evaluation is enabled, whether to evolve a feedforward or recurrent neural network, etc. As used herein, a “mutation parameter” affects the likelihood of a mutation operation occurring with respect to a candidate neural network, the extent of the mutation operation (e.g., how many bits, bytes, fields, characteristics, etc. change due to the mutation operation), and/or the type of the mutation operation (e.g., whether the mutation changes a node characteristic, a link characteristic, etc.). In some examples, the genetic algorithm 810 uses a single mutation parameter or set of mutation parameters for all of the models. In such examples, the mutation parameter may impact how often, how much, and/or what types of mutations can happen to any model of the genetic algorithm 810. In alternative examples, the genetic algorithm 810 maintains multiple mutation parameters or sets of mutation parameters, such as for individual or groups of models or species. In particular aspects, the mutation parameter(s) affect crossover and/or mutation operations, which are further described below.

For an initial epoch of the genetic algorithm 810, the topologies of the models in the input set 820 may be randomly or pseudo-randomly generated within constraints specified by the configuration settings or by one or more architectural parameters. Accordingly, the input set 820 may include models with multiple distinct topologies. For example, a first model of the initial epoch may have a first topology, including a first number of input nodes associated with a first set of data parameters, a first number of hidden layers including a first number and arrangement of hidden nodes, one or more output nodes, and a first set of interconnections between the nodes. In this example, a second model of the initial epoch may have a second topology, including a second number of input nodes associated with a second set of data parameters, a second number of hidden layers including a second number and arrangement of hidden nodes, one or more output nodes, and a second set of interconnections between the nodes. The first model and the second model may or may not have the same number of input nodes and/or output nodes. Further, one or more layers of the first model can be of a different layer type that one or more layers of the second model. For example, the first model can be a feedforward model, with no recurrent layers; whereas, the second model can include one or more recurrent layers.

The genetic algorithm 810 may automatically assign an activation function, an aggregation function, a bias, connection weights, etc. to each model of the input set 820 for the initial epoch. In some aspects, the connection weights are initially assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes or layers of a model may have different types of activation functions. Aggregation functions may similarly be randomly or pseudo-randomly assigned for the models in the input set 820 of the initial epoch. Thus, the models of the input set 820 of the initial epoch may have different topologies (which may include different input nodes corresponding to different input data fields if the data set includes many data fields) and different connection weights. Further, the models of the input set 820 of the initial epoch may include nodes having different activation functions, aggregation functions, and/or bias values/functions.

During execution, the genetic algorithm 810 performs fitness evaluation 840 and evolutionary operations 850 on the input set 820. In this context, fitness evaluation 840 includes evaluating each model of the input set 820 using a fitness function 842 to determine a fitness function value 844 (“FF values” in FIG. 8) for each model of the input set 820. The fitness function values 844 are used to select one or more models of the input set 820 to modify using one or more of the evolutionary operations 850. In FIG. 8, the evolutionary operations 850 include mutation operations 852, crossover operations 854, and extinction operations 856, each of which is described further below.

During the fitness evaluation 840, each model of the input set 820 is tested based on the input data 802 to determine a corresponding fitness function value 844. For example, a first portion 804 of the input data 802 may be provided as input data to each model, which processes the input data (according to the network topology, connection weights, activation function, etc., of the respective model) to generate output data. The output data of each model is evaluated using the fitness function 842 and the first portion 804 of the input data 802 to determine how well the model modeled the input data 802. In some examples, fitness of a model is based on reliability of the model, performance of the model, complexity (or sparsity) of the model, size of the latent space, or a combination thereof.

In a particular aspect, fitness evaluation 840 of the models of the input set 820 is performed in parallel. To illustrate, the system 800 may include devices, processors, cores, and/or threads 880 in addition to those that execute the genetic algorithm 810 and the optimization trainer 860. These additional devices, processors, cores, and/or threads 880 can perform the fitness evaluation 840 of the models of the input set 820 in parallel based on a first portion 804 of the input data 802 and may provide the resulting fitness function values 844 to the genetic algorithm 810.

The mutation operation 852 and the crossover operation 854 are highly stochastic under certain constraints and a defined set of probabilities optimized for model building, which produces reproduction operations that can be used to generate the output set 830, or at least a portion thereof, from the input set 820. In a particular implementation, the genetic algorithm 810 utilizes intra-species reproduction (as opposed to inter-species reproduction) in generating the output set 830. In other implementations, inter-species reproduction may be used in addition to or instead of intra-species reproduction to generate the output set 830. Generally, the mutation operation 852 and the crossover operation 854 are selectively performed on models that are more fit (e.g., have higher fitness function values 844, fitness function values 844 that have changed significantly between two or more epochs, or both).

The extinction operation 856 uses a stagnation criterion to determine when a species should be omitted from a population used as the input set 820 for a subsequent epoch of the genetic algorithm 810. Generally, the extinction operation 856 is selectively performed on models that are satisfy a stagnation criteria, such as modes that have low fitness function values 844, fitness function values 844 that have changed little over several epochs, or both.

In accordance with the present disclosure, cooperative execution of the genetic algorithm 810 and the optimization trainer 860 is used arrive at a solution faster than would occur by using a genetic algorithm 810 alone or an optimization trainer 860 alone. Additionally, in some implementations, the genetic algorithm 810 and the optimization trainer 860 evaluate fitness using different data sets, with different measures of fitness, or both, which can improve fidelity of operation of the final model. To facilitate cooperative execution, a model (referred to herein as a trainable model 832 in FIG. 8) is occasionally sent from the genetic algorithm 810 to the optimization trainer 860 for training. In a particular implementation, the trainable model 832 is based on crossing over and/or mutating the fittest models (based on the fitness evaluation 840) of the input set 820. In such implementations, the trainable model 832 is not merely a selected model of the input set 820; rather, the trainable model 832 represents a potential advancement with respect to the fittest models of the input set 820.

The optimization trainer 860 uses a second portion 806 of the input data 802 to train the connection weights and biases of the trainable model 832, thereby generating a trained model 862. The optimization trainer 860 does not modify the architecture of the trainable model 832.

During optimization, the optimization trainer 860 provides a second portion 806 of the input data 802 to the trainable model 832 to generate output data. The optimization trainer 860 performs a second fitness evaluation 870 by comparing the data input to the trainable model 832 to the output data from the trainable model 832 to determine a second fitness function value 874 based on a second fitness function 872. The second fitness function 872 is the same as the first fitness function 842 in some implementations and is different from the first fitness function 842 in other implementations. In some implementations, the optimization trainer 860 or portions thereof is executed on a different device, processor, core, and/or thread than the genetic algorithm 810. In such implementations, the genetic algorithm 810 can continue executing additional epoch(s) while the connection weights of the trainable model 832 are being trained by the optimization trainer 860. When training is complete, the trained model 862 is input back into (a subsequent epoch of) the genetic algorithm 810, so that the positively reinforced “genetic traits” of the trained model 862 are available to be inherited by other models in the genetic algorithm 810.

In implementations in which the genetic algorithm 810 employs speciation, a species ID of each of the models may be set to a value corresponding to the species that the model has been clustered into. A species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 810 may maintain a data structure that tracks the fitness of each species across multiple epochs. Based on the species fitness, the genetic algorithm 810 may identify the “fittest” species, which may also be referred to as “elite species.” Different numbers of elite species may be identified in different embodiments.

In a particular aspect, the genetic algorithm 810 uses species fitness to determine if a species has become stagnant and is therefore to become extinct. As an illustrative non-limiting example, the stagnation criterion of the extinction operation 856 may indicate that a species has become stagnant if the fitness of that species remains within a particular range (e.g., +/−5%) for a particular number (e.g., 5) of epochs. If a species satisfies a stagnation criterion, the species and all underlying models may be removed from subsequent epochs of the genetic algorithm 810.

In some implementations, the fittest models of each “elite species” may be identified. The fittest models overall may also be identified. An “overall elite” need not be an “elite member,” e.g., may come from a non-elite species. Different numbers of “elite members” per species and “overall elites” may be identified in different embodiments.”

The output set 830 of the epoch is generated based on the input set 820 and the evolutionary operation 850. In the illustrated example, the output set 830 includes the same number of models as the input set 820. In some implementations, the output set 830 includes each of the “overall elite” models and each of the “elite member” models. Propagating the “overall elite” and “elite member” models to the next epoch may preserve the “genetic traits” resulted in caused such models being assigned high fitness values.

The rest of the output set 830 may be filled out by random reproduction using the crossover operation 854 and/or the mutation operation 852. After the output set 830 is generated, the output set 830 may be provided as the input set 820 for the next epoch of the genetic algorithm 810.

After one or more epochs of the genetic algorithm 810 and one or more rounds of optimization by the optimization trainer 860, the system 800 selects a particular model or a set of model as the final model (e.g., a model that is executable to perform one or more of the model-based operations of FIGS. 1-6). For example, the final model may be selected based on the fitness function values 844, 874. For example, a model or set of models having the highest fitness function value 844 or 874 may be selected as the final model. When multiple models are selected (e.g., an entire species is selected), an ensembler can be generated (e.g., based on heuristic rules or using the genetic algorithm 810) to aggregate the multiple models. In some implementations, the final model can be provided to the optimization trainer 860 for one or more rounds of optimization after the final model is selected. Subsequently, the final model can be output for use with respect to other data (e.g., real-time data).

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as, but not limited to, C, C++, C #, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may take the form of or include a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

1. A method comprising:
obtaining multiple datasets of distinct data types;
providing the datasets as input to a plurality of data reduction models to generate digest data for each of the datasets, wherein each data reduction model of the plurality of data reduction models is a machine learning model that is trained to generate digest data for one of the data types;
performing one or more clustering operations to group the digest data into a plurality of clusters, wherein each cluster of the plurality of clusters is associated with a subset of the digest data;
providing a first subset of the digest data as input to one or more event classifiers to generate first event classification data, wherein the first subset of the digest data is associated with a first cluster of the plurality of clusters, and the first event classification data indicates an event classification for a portion of the multiple datasets represented by the first cluster; and
generating output based on the first event classification data.

2. The method of claim 1, wherein the output includes a command to an unmanned system to perform a response action.

3. The method of claim 1, wherein the digest data includes time information and location information associated with at least one dataset of the multiple datasets.

4. The method of claim 1, wherein the digest data includes one or more keywords or one or more descriptors associated with at least one dataset of the multiple datasets.

5. The method of claim 1, wherein the digest data includes one or more features associated with at least one dataset of the multiple datasets.

6. The method of claim 1, wherein the data types include video and the digest data includes identifiers of objects detected in the video.

7. The method of claim 1, wherein the data types include audio data and further comprising generating a transcript of the audio data, wherein the transcript includes natural language text.

8. The method of claim 1, wherein the data types include natural language text including content of one or more social media posts.

9. The method of claim 1, wherein the data types include natural language text of moderated media content.

10. The method of claim 1, wherein a first dataset is obtained via one or more of a public source, an internet source, or a dark web source.

11. The method of claim 1, wherein a second dataset is obtained via a government source.

12. The method of claim 1, wherein a second dataset is obtained via a private source.

13. The method of claim 1, further comprising, after the first event classification data is generated:
searching for additional data using keywords based on the digest data, based on the multiple datasets, or based on both;
generating updated first event classification data based on the additional data; and
updating the one or more event classifiers based on the updated first event classification data.

14. The method of claim 1, further comprising determining a recommended response action based on the first event classification data, wherein the output is based on the recommended response action.

15. The method of claim 14, wherein determining the recommended response action comprises:
selecting one or more event response models based on the first event classification data; and
providing the digest data, the portion of the multiple datasets represented by the first cluster, or both, as input to the one or more selected event response models to generate the recommended response action.

16. The method of claim 15, further comprising, after generating the recommended response action:
obtaining response result data indicating one or more actions taken in response to an event corresponding to the first event classification data and indicating an outcome of the one or more actions; and
updating the one or more selected event response models based on the response result data.

17. The method of claim 16, wherein the one or more selected event response models are updated using a reinforcement learning technique.

18. The method of claim 15, wherein each of the one or more selected event response models performs a response simulation for a particular type of event corresponding to the first event classification data based on a time and location associated with the portion of the multiple datasets represented by the first cluster.

19. A system for event classification, the system comprising:
one or more interfaces configured to receive datasets from multiple distinct data sources;
one or more memory devices storing a plurality of data reduction models, clustering instructions, and one or more event classifiers; and
one or more processors configured to execute instructions from the one or more memory devices to:
provide the datasets as input to the plurality of data reduction models to generate digest data for each of the datasets, wherein each data reduction model of the plurality of data reduction models is a machine learning model that is trained to generate digest data for one of the data types;
execute the clustering instructions to group the digest data into a plurality of clusters, wherein each cluster of the plurality of clusters is associated with a subset of the digest data;
provide a first subset of the digest data as input to the one or more event classifiers to generate first event classification data, wherein the first subset of the digest data is associated with a first cluster of the plurality of clusters, and the first event classification data indicates an event classification for a portion of the datasets represented by the first cluster; and
generate output based on the first event classification data.

20. The system of claim 19, wherein the one or more interfaces are configured to transmit, based on the output, a command to an unmanned system to perform a response action.

21. The system of claim 19, wherein the one or more memory devices further store speech recognition instructions that are executable by the one or more processors to generate natural language text based on audio data received via the one or more interfaces.

22. The system of claim 19, wherein the one or more memory devices further store automated model builder instructions that are executable by the one or more processors to update the one or more event classifiers based on updated event classification data received after the first event classification data is generated.

23. The system of claim 19, wherein the output includes one or more recommended response actions based on the first event classification data.

24. The system of claim 23 Error! Reference source not found., wherein the one or more memory devices further store one or more event response models that enable the one or more processors to determine the one or more recommended response actions.

25. The system of claim 24, wherein the one or more event response models include heuristic rules that map particular event types to corresponding response actions.

26. The system of claim 24, wherein the one or more event response models include response simulation models.

27. A non-transitory computer-readable storage device storing instructions that are executable by one or more processors to cause the one or more processors to perform operations comprising:
obtaining multiple datasets of distinct data types;
providing the datasets as input to a plurality of data reduction models to generate digest data for each of the datasets, wherein each data reduction model of the plurality of data reduction models is a machine learning model that is trained to generate digest data for one of the data types;
performing one or more clustering operations to group the digest data into a plurality of clusters, wherein each cluster of the plurality of clusters is associated with a subset of the digest data;
providing a first subset of the digest data as input to one or more event classifiers to generate first event classification data, wherein the first subset of the digest data is associated with a first cluster of the plurality of clusters, and the first event classification data indicates an event classification for a portion of the multiple datasets represented by the first cluster; and
generating output based on the first event classification data.
